(19) United States
(12) Patent Application Publication
(10) Pub. No.: US 2013/0249748 A1
(43) Pub. Date: Sep. 26, 2013

(54) ANTENNA DEVICE, AND MOVING BODY EQUIPPED WITH ANTENNA DEVICE

(71) Applicant: FUJIKURA LTD., Tokyo (JP)

(72) Inventors: Takeshi Togura, Sakura-shi (JP); Ning Guan, Sakura-shi (JP); Hiroki Nitta, Sakura-shi (JP); Yuichiro Yamaguchi, Sakura-shi (JP); Yuki Noguchi, Tokyo (JP)

(73) Assignee: FUJIKURA LTD., Tokyo (JP)

(21) Appl. No.: 13/896,689

(22) Filed: May 17, 2013

Related U.S. Application Data
(63) Continuation of application No. PCT/JP2011/076714, filed on Nov. 18, 2011.

(30) Foreign Application Priority Data
Nov. 19, 2010 (JP) 2010-259588

(51) Int. Cl. H01Q 1/32

(52) U.S. Cl. CPC H01Q 1/32
USPC 343/713

(57) ABSTRACT

An antenna device includes: a plate-like antenna having an electrically conductive path arranged in a two-dimensional manner, the electrically conductive path having a meander shape which is made up of at least one return pattern; and a base member, while causing the antenna to be spaced away from an outer surface of a body containing an electrically conductive material layer of a movable body, holding the antenna in such a manner as to conform to the outer surface, the base member being made from a dielectric material.

### CROSS-REFERENCE TO RELATED APPLICATIONS

This application is a Continuation of PCT International Application No. PCT/JP2011/076714 filed in Japan on Nov. 18, 2011, which claims the benefit of Patent Application No. 2010-259588 filed in Japan on Nov. 19, 2010, the entire contents of which are hereby incorporated by reference.

### TECHNICAL FIELD

The present invention mainly relates to an antenna device which is mounted on a movable body such as an automobile and is suitable for a wireless device.

### BACKGROUND ART

For example, in the field of an in-car antenna to be mounted on an automobile, recent advance in a communication network has caused development of various antennas which are suitable for various frequency bands to be used.

For example, car navigation systems are connected with various kinds of antennas which are suitable for transmission and reception of microwaves of 1 GHz to 10 GHz and are used in ITS (Intelligent Transport Systems) such as GPS (Global Positioning System), VICS (Vehicle information and Communication System®), and ETC (Electronic Toll Collection).

Further, it is general that a car navigation system is integrally provided with not only the ITS but also a tuner which receives radio broadcasting and terrestrial digital broadcasting. Accordingly, a frequency band used by an in-car antenna includes an AM frequency of 526.5 kHz to 1606.5 kHz, a band of 60 MHz, a VHF frequency of 87.5 MHz to 108 MHz, a UHF frequency (470 MHz to 770 MHz) for terrestrial digital broadcasting, a service of which has been recently started in three wide areas of Japan, i.e. Kanto, Kinki, and Chukyo areas in Japan. Thus, the band covers a wide range.

The terrestrial digital broadcasting makes it possible to provide not only a digital high-definition and high sound quality program but also an interactive program, so that a program in which images are clear without flickering can be viewed even with a television installed in, for example, a running train or bus. Further, it is scheduled to provide a service that allows a mobile information terminal or the like to receive and view a moving image, data broadcasting, or voice broadcasting.

For example, as shown in FIG. 26, an in-car antenna device 50, which is disclosed in Patent Literature 1 listed below, includes: an AM/TEL antenna which is incorporated into an antenna case 52 mounted onto a roof 51 of a vehicle; and an FM glass antenna 56 which is provided together with a heater line 55 on a rear glass 54 shown in FIG. 27. An antenna circuit 57 incorporated into the antenna case 52 carries out impedance conversion for an AM antenna and also carries out matching and amplification of an incoming signal in a FM frequency band, after which the antenna circuit 57 mixes AM incoming signal with the FM incoming signal and then outputs the mixture signal.

It should be noted that the AM/TEL antenna 53 transmits and receives radio waves in an AM broadcast band and radio waves in a frequency band of an automobile telephone. Further, a GPS antenna 58 and a satellite radio antenna 59, which receives radio waves in a frequency band of a satellite radio, are incorporated into the antenna case 52. These antennas 53, 58, and 59 are firmly fixed onto, for example, an antenna base 60 made from a metal.

Further, Patent Literature 2 listed below discloses a technique of placing an antenna in film form by standing the antenna upright on a surface of a vehicle body, in order to improve a reception sensitivity of the antenna.

On the other hand, Patent Literature 3 listed below discloses a helical coil antenna 70, which is one form of a rod antenna, as shown in FIG. 28. According to the helical coil antenna 70, a circuit board 73 which is provided on a base plate 72 made of metal is contained in a base casing 71 fixed on a body panel BP. The base plate 72 is provided with a BNC connector 74 to which a feed cord C is connected from outside the base plate 72.

Further, the helical coil antenna 70 is provided with an antenna element 75 whose base end is supported by the base casing 71. The antenna element 75 is constituted by a helical coil 76 and an antenna casing 77 which covers the helical coil 76.

Note that each of the BNC connector 74 and the antenna element 75 is electrically connected to the circuit board 73.

### CITATION LIST

### Patent Literatures

Patent Literature 1
Japanese Patent Application Publication, Tokukai, No. 2008-22430 (Publication Date: Jan. 31, 2008)
Patent Literature 2
Japanese Patent Application Publication, Tokukai, No. 2009-76962 (Publication Date: Apr. 9, 2009)
Patent Literature 3
Japanese Patent Application Publication, Tokukai, No. 2000-295017 (Publication Date: Oct. 20, 2000)

### SUMMARY OF INVENTION

### Technical Problem

However, when the antennas are made close to and placed in parallel with a surface (metal surface) of a metal constituting an outer shell of a vehicle body, performances of the antennas significantly decrease. In view of this, the antennas which are disclosed in Patent Literatures listed above are provided such that end parts of the antennas are spaced away from the surface of the vehicle body. This, however, causes a common problem that a space occupied by the antenna increases in a direction of a height of the vehicle body which height extends from the surface of the vehicle body.

For example, according to the in-car antenna device 50 of Patent Literature 1, the incorporated AM/TEL antenna 53 is provided in an upright position with respect to the roof 51 so that the AM/TEL antenna 53 is spaced away from the metal surface of the roof 51. Also, the helical coil antenna 70 of Patent Literature 3 has such a structure that the antenna element 75 stands upright on the body panel BP, so that the antenna element 75 can be spaced from the metal surface of the body panel BP.

As such, the in-car antenna device 50, as is also called “shark fin antenna” from an appearance of the antenna case 52, is arranged such that the end part of the antenna is spaced away from the roof 51. As a result, the in-car antenna device 50 has not only a problem of increasing its occupied space, but also a design problem of being not aesthetically pleasing.

Like the in-car antenna device 50 and the helical coil antenna 70, the antenna increasing its occupied space in a direction of a height of a vehicle body also has a problem of interfering with parking of an automobile in a multilevel parking lot with a maximum height to vehicles.

Furthermore, the rod antenna like the helical coil antenna 70 can interfere with parking of an automobile in a multilevel parking lot, and the rod antenna may also be damaged by a rotatable brush used in an automatic car-washing machine or may be stuck on a tree or the like and damaged. By the way, in a case where a core made from an elastic and soft material and winding a coil thereon is used for a rod antenna, such a rod antenna is less likely to be broken with flexibility (safety). However, the rod antenna capable of being freely bent gives rise to problems such as a gain depression and a decrease in radiation efficiency. In particular, in the event of being bent by vibration, the rod antenna suffers from uneven winding pitch of the coil, thus causing a change in impedance.

The present invention has been attained in view of the above problems, and an object of the present invention is to provide a planar, low-profile antenna that permits installation on an outer surface of an outer shell of a movable body which outer shell includes an electrically conductive material layer, while conforming to the outer surface of the outer shell.

### Solution to Problem

In order to solve the above problems, an antenna device according to the present invention is configured to include:

(1) a plate-like antenna element having an electrically conductive path arranged in a two-dimensional manner;

(2) a feed line connected to the antenna element; and

(3) a support, while causing the antenna element to be spaced away from an electrically conductive material layer of an outer shell of a movable body, holding the plate-like antenna element in such a manner as to conform to a front surface or a back surface of the outer shell,

(4) the plate-like antenna element including: (i) a first root section being a part of the antenna element which part extends from one end part of the electrically conductive path by a predetermined length; (ii) a second root section being a part of the antenna element which part extends from the other end part of the electrically conductive path by a predetermined length; and (iii) an intermediate section which is a junction between the first root section and the second root section,

(5) the first and second root sections having first and second feed sections respectively provided therein, the first and second feed sections being each connected to the feed line,

(6) the intermediate section having the electrically conductive path provided therein, the electrically conductive path having a meander shape with a return pattern, and

(7) the support being made from a dielectric material.

It should be noted that the movable body may be translated into a locomotive machine that requires power for its movement. A typical example of the movable body is an automobile. In addition, examples of the movable body include general vehicles on or off rail tracks, a manned or unmanned flight vehicle such as an artificial satellite, and a manned or unmanned submarine, without particular limitation to types of the movable body.

A typical example of the outer shell containing the electrically conductive material layer in the movable body is a metal generally used as a material for bodies of an automobile, an airplane, a train, a ship, etc. However, the outer shell is not limited to metal as long as it has stiffness required for the body. Examples of the outer shell may include an electrically conductive resin and others.

Note that a plane of the above “plate-like antenna element having an electrically conductive path arranged in a two-dimensional manner” is not limited to a two-dimensional plane but may be a plane which (i) is obtained by cutting off a part of a curved surface such as a cylindrical surface, a spherical surface, a paraboloid, or a hyperboloid and (ii) has a three-dimensional shape.

Note also that a movable body having the antenna device mounted on a front surface or a back surface of an outer shell thereof is also included within the scope of the present invention.

### Advantageous Effects of Invention

The above configuration allows an antenna device of the present invention to achieve the effect of providing a planar, low-profile antenna that permits installation on a front surface or a back surface of an outer shell of a movable body which outer shell includes an electrically conductive material layer, while conforming to the front surface or the back surface of the outer shell.

### BRIEF DESCRIPTION OF DRAWINGS

FIG. 1 is a cross-sectional view schematically illustrating a configuration example of an antenna device according to an embodiment of the present invention.

FIG. 2 is a cross-sectional view schematically illustrating a configuration of a modified example of the antenna device.

FIG. 3 is a cross-sectional view schematically illustrating still another example of a configuration of the antenna device.

FIG. 4 is a cross-sectional view schematically illustrating yet another example of a configuration of the antenna device.

FIG. 5 schematically illustrates a configuration of a modified example of the antenna devices shown in FIGS. 3 and 4 and is a cross-sectional view illustrating a part of the configuration in an enlarged view.

FIG. 6 is a view illustrating a manner in which an antenna according to the present invention is provided on, while conforming to, an inside surface of an exterior material in such a state that the antenna is spaced a distance away from the inside surface of the exterior material.

FIG. 7 is a view illustrating a manner in which an antenna according to the present invention is installed on the inside surface of the exterior material via an insulating material.

FIG. 8 is an enlarged view of a pillar supporting a roof, out of the components in the appearance configuration shown in FIG. 10.

FIG. 9 is a view illustrating an example of a cross-section of the pillar shown in FIG. 8 when the pillar is cut at a predetermined position by a plane H which intersects a longitudinal direction of the pillar.

FIG. 10 is a view illustrating an example of an appearance configuration of a front side of a cabin of an automobile shown in FIG. 11.

FIG. 11 is a view schematically illustrating specific examples of where in an automobile an antenna device of the present invention is to be mounted.

FIG. 12 is a plan view schematically illustrating a configuration of an antenna in accordance with an embodiment of the present invention.

FIG. 13 is a view schematically illustrating how a short-circuit member is provided in an antenna element having a meander shape so as to form a plurality of electrically conductive paths in the antenna element.

FIG. 14 is a view schematically describing how measurements are carried out in experiments for showing the effects of an antenna of the present invention.

FIG. 15 is a plan view schematically illustrating a configuration of an example for comparison with the antenna shown in FIG. 12.

FIG. 16 is a graph illustrating VSWR characteristics of the antenna shown in FIG. 12 and of the antenna shown in FIG. 15.

FIG. 17 is a graph illustrating VSWR characteristics of an antenna device including the antenna of FIG. 12, which VSWR characteristics were measured while the thickness of a dielectric material shown in FIG. 14 was being changed.

FIG. 18 shows graphs illustrating radiation patterns of the antenna shown in FIG. 12. (a) of FIG. 18 illustrates an in-xy-plane radiation pattern. (b) of FIG. 18 illustrates an in-yz-plane radiation pattern. (c) of FIG. 18 illustrates an in-zx-plane radiation pattern.

FIG. 19 is a plan view schematically illustrating a configuration of a modified example of an antenna in accordance with an embodiment of the present invention.

FIG. 20 is a plan view schematically illustrating a configuration of another modified example of an antenna in accordance with an embodiment of the present invention.

FIG. 21 is a plan view schematically illustrating a configuration of still another modified example of an antenna in accordance with an embodiment of the present invention.

FIG. 22 is a graph illustrating VSWR characteristics of the antenna shown in FIG. 19, of the antenna shown in FIG. 20, and of the antenna shown in FIG. 21.

FIG. 23 is a graph illustrating VSWR characteristics of an antenna device including the antenna of FIG. 19, which VSWR characteristics were measured while the thickness of a dielectric material was being changed.

FIG. 24 shows graphs illustrating radiation patterns of the antenna shown in FIG. 19. (a) of FIG. 24 illustrates an in-xy-plane radiation pattern. (b) of FIG. 24 illustrates an in-yz-plane radiation pattern. (c) of FIG. 24 illustrates an in-zx-plane radiation pattern.

FIG. 25 is a plan view schematically illustrating a configuration of yet another modified example of an antenna in accordance with an embodiment of the present invention.

FIG. 26 is an explanatory view illustrating a configuration of the conventional in-car antenna device.

FIG. 27 is an explanatory view illustrating a configuration of an FM glass antenna of the in-car antenna device shown in FIG. 26.

FIG. 28 is a cross-sectional view illustrating a configuration of the conventional helical coil antenna.

### DESCRIPTION OF EMBODIMENTS

The following will describe an embodiment of the present invention with reference to the drawings.

### Constitution Example 1 of Antenna Device

FIG. 1 is a cross-sectional view schematically showing a configuration example of an antenna device according to the embodiment of the present invention, and showing a state in which a body 2 (outer shell) of a movable body has an antenna device 1 placed on its surface (hereinafter referred to as “outer surface”).

Taken as a typical example of the movable body is an automobile 601 shown in FIG. 11. Examples of a component equivalent to the outer surface of the body 2 shown in FIG. 1 include a rooftop 611, a bumper 612, a rear spoiler 613, a door 614, a side mirror 615, a trunk cover 616, and a hood 617. A major feature of the antenna device 1 according to the present invention is that the antenna device 1 can be placed on, while conforming to, not only a surface of a component which is made from a non-metallic material like a resin material, but also a surface of a component which is made from a metallic material, among the above-described components equivalent to the body 2. The reason for such a feature will be detailed later.

Thus, FIG. 1 shows a configuration example of the antenna device 1 that is placed on the body 2 of the component which is made from an electrically conductive material like a metal. With such a precondition, the antenna device 1 will be more specifically described below.

As shown in FIG. 1, the antenna device 1 includes an antenna 3 and a base member 5 made from a dielectric material. The antenna device 1 further includes fixing means (not shown) for fixing the plate-like base member 5 on the surface of the body 2.

According to the antenna device 1 shown in FIG. 1, the antenna 3 and a tuner section 4 (transmitting and receiving circuit) are provided side by side. The antenna 3 and the tuner section 4 are provided on a top surface (a single plane) of the base member 5. Further, according to the antenna device 1 shown in FIG. 1, a radome 6 is provided to cover the antenna 3 and the tuner section 4 therewith, and the antenna 3 and the tuner section 4 are accommodated within a case constituted by the base member 5 and the radome 6.

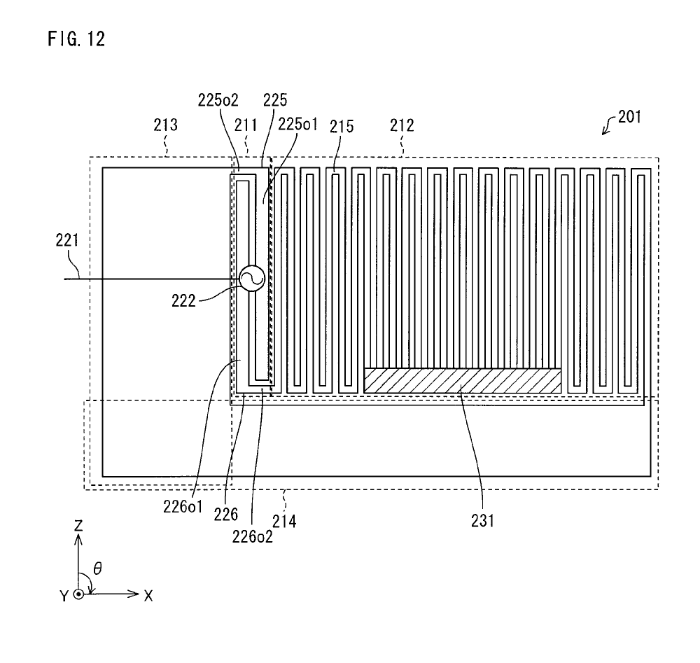

As will be described later with reference to FIG. 12, the antenna 3 includes: (i) an antenna element 215 having an electrically conductive path which is arranged in a two-dimensional manner; and (ii) a feed line 221 which is connected to the antenna element 215. It should be noted that the antenna device 1 has flexibility.

Further, the antenna 3 (the antenna 3 may be translated here into the antenna element 215) is held in such a state that the antenna 3 is spaced away from the outer surface of the body 2 by a thickness D of the base member 5. In order that the antenna device 1 exhibits its excellent characteristics, it is preferable that the antenna 3 be spaced away from a conductor by setting the thickness D of the base member 5, i.e. the thickness of the dielectric material to not less than 2 mm.

The radome 6, which is a cover member for covering the antenna 3 therewith, is made from a material having high inductive capacity and high stiffness. Further, the radome 6 is brought into intimate contact with the base member 5 or the body 2 via a gasket or the like which is used to secure resistance to water. The radome 6 is fixed on the base member 5 or the body 2 by securing the radome 6 to the base member 5 or the body 2 by screws or the like at a plurality of places, for example, as indicated by arrows A1 and A2 in FIG. 1.

As described above, in the Configuration Example 1, the antenna 3 can be provided on the outer surface of the body 2, while conforming to the outer surface of the body 2, in such a state that the antenna 3 is spaced away from the outer surface of the body 2. With this arrangement, the antenna device 1 can have a much lower height H1 and thus achieve reduction in thickness, as compared to the in-car antenna device 50 or the helical coil antenna 70, which have been introduced as conventional art.

Further, with the arrangement in which the antenna 3 and the tuner section 4 are provided side by side on a single surface of the base member 5, it is possible to shorten a conduction route for connection between the antenna 3 and the tuner section 4. This makes it possible to reduce a loss caused by the conduction route and eliminates the need for consideration to impedance of a transmission route between the antenna 3 and the tuner section 4.

### Configuration Example 2 of Antenna Device

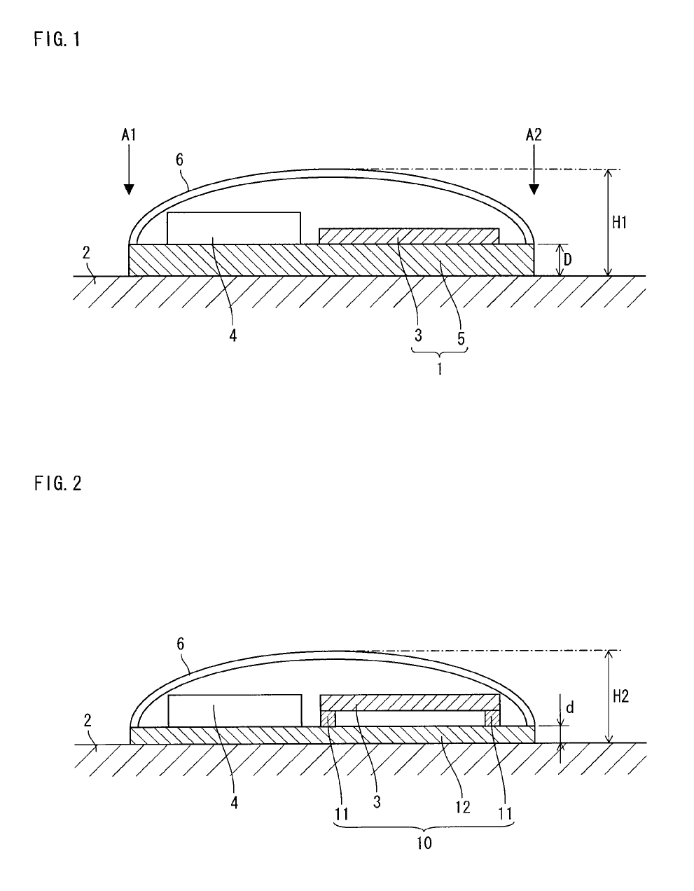

FIG. 2 is a cross-sectional view schematically illustrating a configuration of an antenna device 10 as a modified example of the antenna device 1. The antenna device 10 is mainly different from the antenna device 1 in that the antenna 3 is held by a spacer 11 (support), which is made from a dielectric material, so as to be spaced away from the outer surface of the body 2 and in that by virtue of employing the spacer 11 as a support, the base member 5 is replaced by a base member 12 which is smaller in thickness than the base member 5.

In the case of the antenna device 10, dielectric materials present between the antenna 3 and the outer surface of the body 2 are as follows. That is, dielectric materials in a place where the spacer 11 is set are the spacer 11 and the base member 12, while dielectric materials in a place other than the place where the spacer 11 is set are an air layer and the base member 12. Since the air layer effectively functions as a dielectric material which causes the antenna 3 to be spaced away from the outer surface of the body 2, the base member 12 is not necessarily provided.

As a thickness d of the base member 12 is smaller than the thickness D of the base member 5, a height H2 of the antenna device 10 is smaller than the height H1 of the antenna device 1 accordingly. This allows the antenna device 10 to be much thinner than the antenna device 1.

It should be noted that how the spacer 11 is provided is not particularly limited as long as the spacer 11 can hold the antenna 3 so as to cause the antenna 3 to be spaced 2 mm or more, including the thickness d of the base member 12, away from the outer surface of the body 2

### Configuration Example 3 of Antenna Device

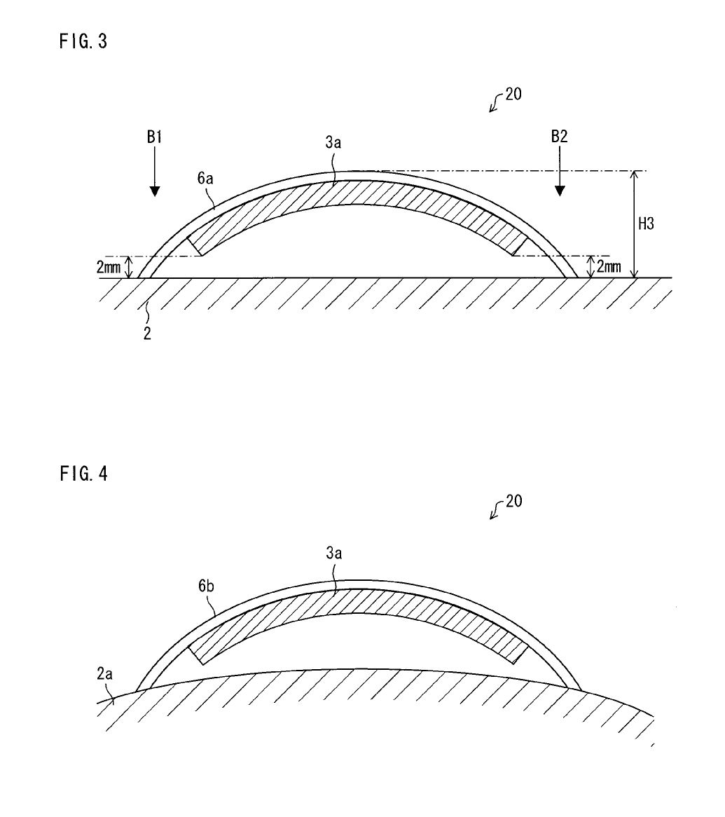

FIG. 3 is a cross-sectional view schematically showing still another example of a configuration of an antenna device. An antenna device 20 includes an antenna 3a and a radome 6a (support, cover member) (see FIG. 3). The antenna device 20 further includes fixing means (not shown) for fixing the radome 6a on the surface of the body 2.

As in the case with the radome 6, the radome 6 is a cover member for covering an antenna therewith. The radome 6 also serves as a support for holding the antenna 3a in such a manner as to conform to the outer surface of the body 2, while causing the antenna 3a to be spaced away from the outer surface of the body 2.

That is, the antenna 3a is provided on, while conforming to, an inner surface (inside surface) of the radome 6a in such a state that there is provided a space between the outer surface of the body 2 and the antenna 3a. More specifically, in a region of the inner surface of the radome 6a which region is located so as to be spaced 2 mm or more away from the outer surface of the body 2, the antenna 3a is provided on, while conforming to, the inner surface of the radome 6a, and is formed in such a shape that the antenna 3a is raised in a direction which decreases proximity to the outer surface of the body 2. As a result of this, the whole antenna 3a including their end faces is 2 mm or more away from the outer surface of the body 2, as shown in FIG. 3.

As described previously, the antenna 3a has flexibility. This makes it possible to fix the antenna 3a on the inner surface of the radome 6a by using an adhesive agent, an adhesive tape, or the like. It should be noted that a shape of the radome 6a can be selected from curved surface shapes obtained by cutting off a part of a curved surface such as a spherical surface, a paraboloid, an ellipsoid, a hyperboloid, or a cylindrical surface.

Due to the absence of a base member in the antenna device 20, a height H3 of the antenna device 20, i.e. a distance between an apex of the radome 6a and the outer surface of the body 2 is much smaller than the height H1 of the foregoing antenna device having the antenna arranged on the base member 5 and the height H2. Therefore, the antenna device 20 can be configured to be a thinnest antenna device.

The outer surface of the body 2 is depicted as a flat surface in the configuration examples shown in FIGS. 1 through 3. However, as a matter of course, the outer surface of the body 2 is not limited to a flat surface and may be a curved surface 2a, as shown in FIG. 4. In a case where the outer surface of the body 2 is formed in curved surface shape, the curved surface shape may be a curved surface shape obtained by cutting off a part of a curved surface such as a spherical surface, a paraboloid, an ellipsoid, a hyperboloid, or a cylindrical surface.

In this case, the base member 5 shown in FIG. 1 and the base member 12 shown in FIG. 2 have the same shape as the curved surface 2a. Accordingly, the antenna 3 arranged on the base member 5 or the base member 12 has the same shape as the curved surface 2a. Further, the radome 6a shown in FIG. 3 is replaced by a radome 6b, as shown in FIG. 4, having a shape conform to the curved surface shape.

Note that the radome 6a is brought into intimate contact with the body 2 via a gasket or the like which is used to secure resistance to water. The radome 6a is fixed on the body 2 by securing the radome 6a to the body 2 by screws or the like at a plurality of places, for example, as indicated by arrows B1 and B2 in FIG. 3. Such a fixing mechanism is also applied to the radome 6b.

### Configuration Example 4 of Antenna Device

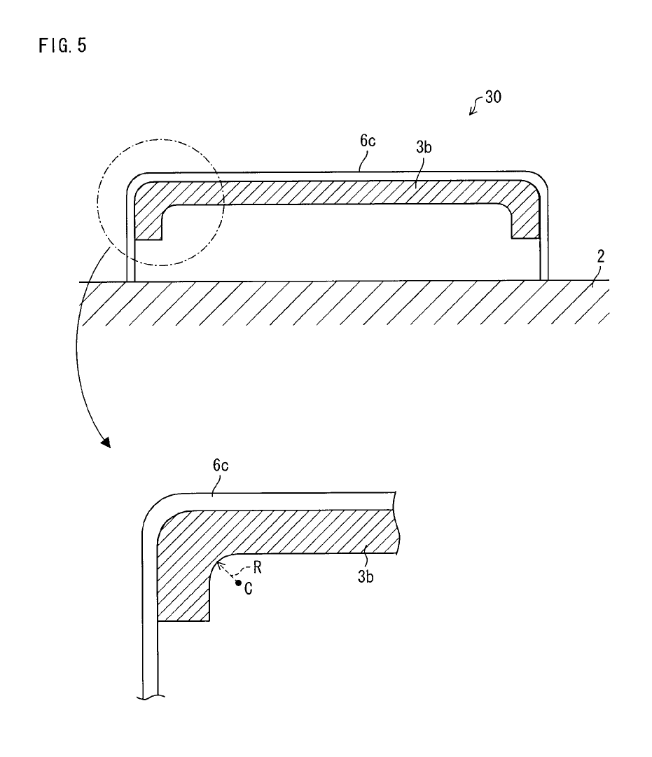

FIG. 5 is a cross-sectional view schematically showing a configuration example of an antenna device 30 as a modified example of the antenna device 20. The antenna device 20 includes an antenna 3b and a radome 6c (support, cover member) (see FIG. 5).

The radome 6c has such a shape that a rectangular, flattened tray is inverted on the outer surface of the body 2. However, the radome 6c is arranged such that boundaries (edge lines) between an upper surface of the radome 6c and side surfaces thereof that extend nearly vertically with respect to the upper surface, i.e. corners (edges) of the radome 6c are not sharp but rounded. More specifically, as FIG. 5 partially shows an enlarged view of one of the corners, the corners are each rounded to such an extent that a curvature radius R is not less than 5 mm. Note that a letter C indicated in FIG. 5 represents a center of the curvature radius R.

The antenna 3b is provided, while conforming to a shape of the inner surface of the rounded corners, so as to be spaced 2 mm or more away from the outer surface of the body 2. Thus, an antenna of the present invention can maintain excellent characteristics, provided that the antenna is mounted on, while conforming to, a curved surface having a curvature radius R of not less than 5 mm, regardless of whether the antenna is mounted to the outer surface of the body or to the inner surface of the radome.

(Back Surface of Outer Shell on which the Antenna Device is Installed)

Next, the following will describe, as an example of a place where an antenna device of the present invention is to be installed, a back surface of the body 2 (an interior-side surface or a cabin-side surface). In the body 2, a back surface of a cabin body, which constitutes a cabin of a vehicle, is not visibly seen by a person because it is generally covered with an interior material of the cabin body. Thus, the installation of the antenna device on the back surface of the cabin body means that the antenna device is provided in a space which is formed between an exterior material of the cabin body and the interior material thereof. This eliminates the impairment of exterior and interior designs of the automobile 601.

Note that the body 2 includes not only the cabin body but also an exterior body. For example, the exterior body includes a hood 617, a bumper 612, and a trunk cover 616, as shown in FIG. 11. In addition, a rear spoiler 613 which is integrated into the body 2 may be included as the exterior body or may be included as a detachable external component serving as a car accessory.

Basically, the back surface of the exterior body is not visibly seen by a person. It is therefore general that the back surface of the exterior body is not covered with any interior material, unlike the cabin body. However, such a back surface of the exterior body can be selected as a place where the antenna device of the present invention is to be installed.

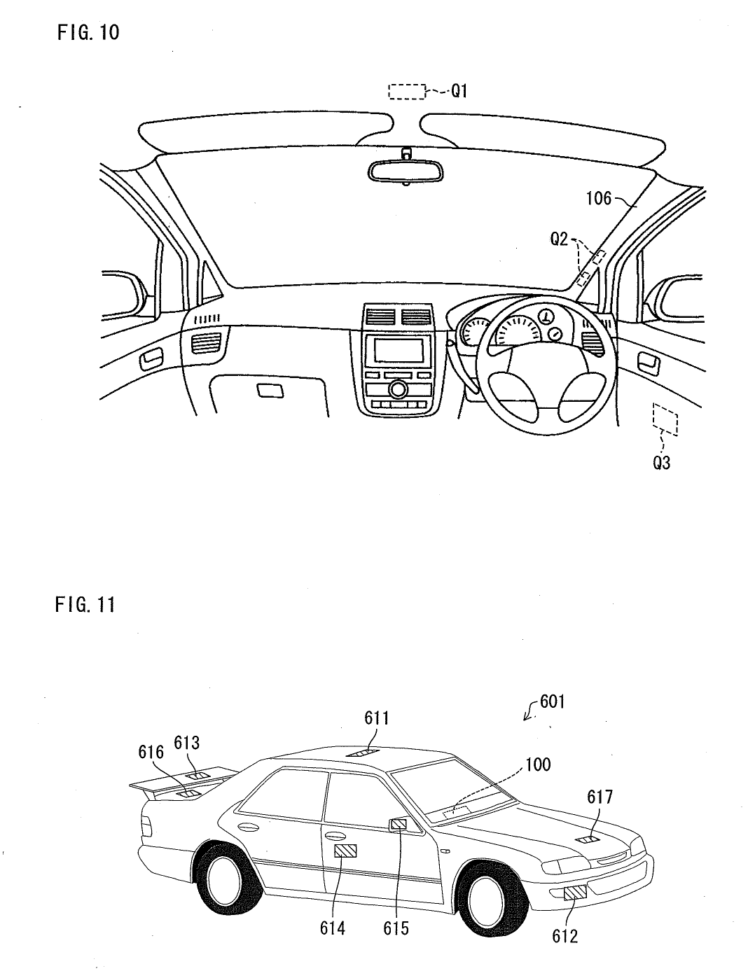

FIG. 10 is a view illustrating an example of an appearance configuration of a front side of the cabin of the automobile 601. As shown in FIG. 10, examples of the place where the antenna device is to be installed on the back surface of the cabin body include, but are not limited to, a roof trim Q1, a front pillar trim Q2, and a door trim Q3. It is desirable that the antenna device be installed at, for example, a position close to a window or a sunroof or the like position where the antenna device can receive strong radio waves which result from diffraction of incoming radio waves passing through a window or other component which is not the metallic exterior material.

### Configuration Example 5 of the Antenna Device

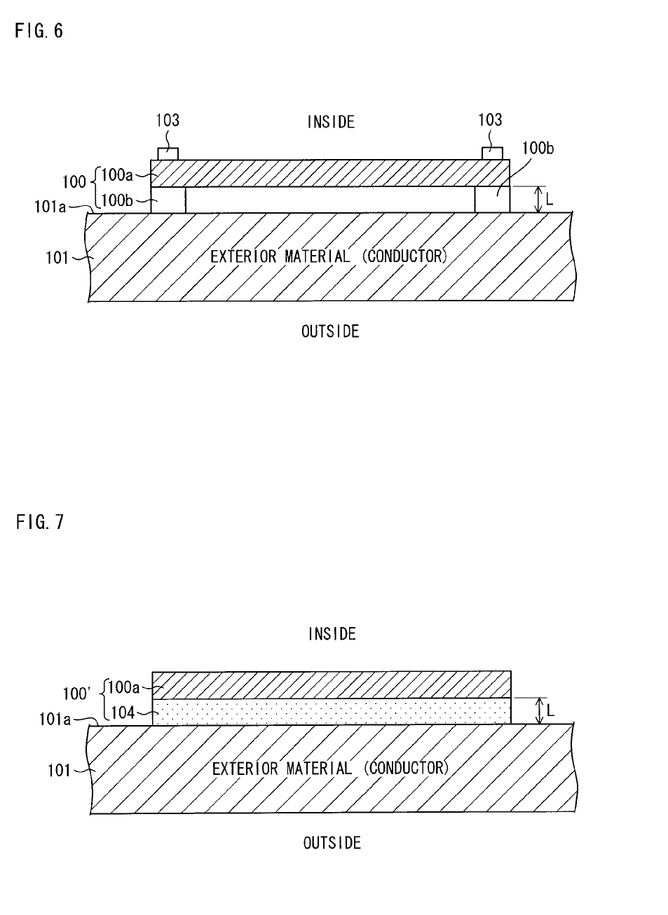

FIG. 6 shows a manner in which an antenna device 100 of the present invention is provided on an inside surface 101a of an exterior material 101 which is constituted by a conductor. As shown in FIG. 6, the antenna device 100 includes: an antenna 100a; and spacers 100b serving as a support. In a case where the antenna device 100 is provided on the inside surface 101a of the exterior material 101, the antenna 100a is provided so as to be spaced away from the inside surface 101a. In view of the VSWR characteristics, a distance L at which the antenna 100a is spaced away from the inside surface 101a is set to, for example, 2 mm. However, the distance L is not limited to 2 mm, but may be equal to or greater than 2 mm which allows the VSWR to be prevented from being greater than 3.5.

In such a manner, the antenna 100a needs only to be spaced 2 mm or greater away from the inside surface 101a of the exterior material 101. This allows the antenna device 100 to be provided even in a relatively narrow space. As such, the antenna device 100 needs only a small space for its installation and has a high degree of freedom in installation.

In a case where the antenna device 100 is to be installed at the distance L, the following arrangement can be considered. For example, as shown in FIG. 6, a predetermined number of spacers (insulating material) 100b each having a thickness equivalent to the distance L is provided at appropriate points of the inside surface 101a. The antenna 100a is placed on the spacers 100b and fixed to the spacers 100b by mounting parts 103 such as screws.

### Configuration Example 6 of the Antenna Device

Instead of the configuration shown in FIG. 6, an antenna device 100′ may be configured such that an insulating material 104 in sheet form having a thickness equivalent to the distance L is placed on the inside surface 101a of the exterior material 101, and the antenna 100a is placed on such an insulating material 104 (see FIG. 7). In other words, the antenna device 100′ may be configured in such a manner that the insulating material 104 lies between the antenna 100a and the inside surface 101a of the exterior material 101.

### Configuration Example 7 of the Antenna Device

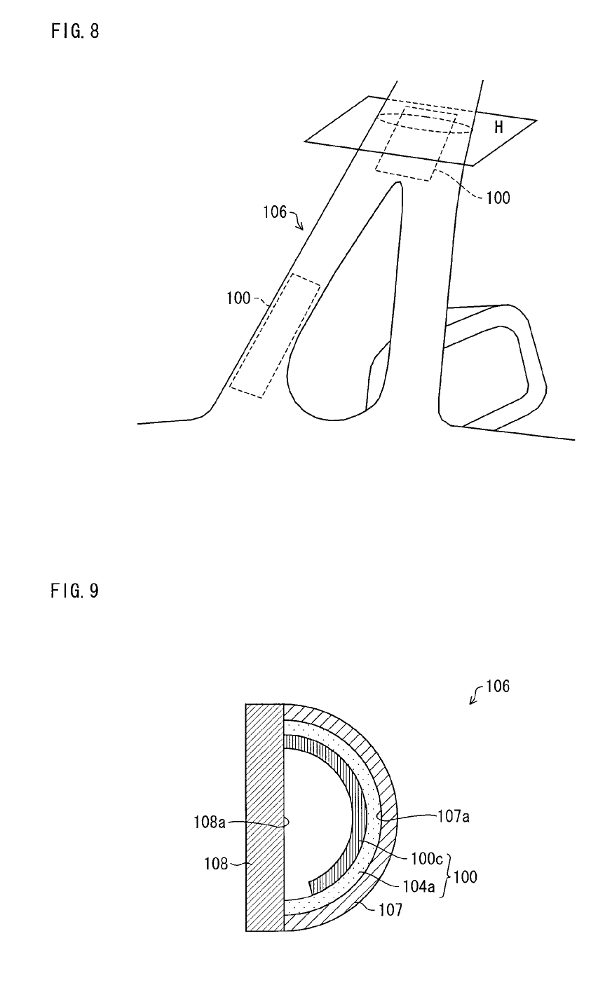

The following will describe an example of installation of the antenna device 100 on a front pillar in the above-described installation manner. FIG. 8 is an enlarged view of a pillar 106 supporting a roof, out of the components in the appearance configuration shown in FIG. 10. It should be noted that the following description also applies to the antenna device 100′ in a similar manner.

As shown in FIG. 8, the antenna device 100 can be installed so as to be incorporated into, for example, a pillar 106. The pillar 106 is close to a window and is therefore a place where the antenna device can be expected to receive strong radio waves which result from diffraction of incoming radio waves. In FIG. 8, an example of a portion where the antenna device 100 can be installed in the pillar 106 is indicated by a dotted line. FIG. 9 is a view illustrating an example of a cross-section of the pillar 106 shown in FIG. 8 when the pillar 106 is cut at a predetermined position by a plane H which intersects a longitudinal direction of the pillar 106.

The pillar 106 shown in FIG. 9 has (i) the exterior material (exterior body) 107 made from a conductor and (ii) the vehicle-use interior material 108 made from a synthetic resin. The exterior material 107 has an arc-shaped cross section, whereas the interior material 108 has a linear cross section or an arc-shaped cross section (FIG. 9 shows the interior material having a linear cross section). The pillar 106 has a tubular shape (hollow structure) which is realized by coupling the exterior material 107 to the interior material 108 in such a state that an end part of the cross section of the exterior material 107 is in direct contact with an end part of the cross section of the interior material 108.

In the pillar 106 arranged as above, the antenna device 100 can be installed, in the aforementioned manners of installation, on an inside surface 107a of the exterior material 107 or a cavity-side surface 108a of the interior material 108, while conforming to an inside surface 107a or the cavity-side surface 108a.

More specifically, for example, as shown in FIG. 9, the antenna device 100 including the antenna 100c and the insulating material 104a in sheet form can be installed on, while conforming to, the inside surface 107a in such a state that a distance of 2 mm or greater provided between the antenna 100c and the inside surface 107a of the exterior material 107 is secured by intervention of the insulating material 104a. Alternatively, although not specifically shown in the drawings, the antenna device 100 can be installed on the inside surface 107a of the exterior material 107 by using the spacers 100b and the mounting parts 103 such as screws, both of which are shown in FIG. 6.

### Example 1 of Detailed Configuration of Antenna

Next, the following will detail a configuration of an antenna of the present invention such that a distance of at least 2 mm between the antenna element and a conductor surface allows the antenna to ensure its excellent characteristics even when the antenna is placed on the conductor surface while conforming to the conductor surface.

Meanwhile, an antenna is susceptible to the surrounding environment. Therefore, how the antenna is mounted in such a position is important.

In particular, if an antenna is mounted on a conductor member made of a metal plate etc., the antenna is inevitably affected by the conductor member. That is, in a case where the antenna is to be mounted on a conductor member, the antenna needs to be designed in view of the effect of the conductor member, unlike a case where the antenna alone is present in a vacuum free space.

In view of this, the antenna of the present invention is configured on the assumption that it is to be affected by the conductor member when mounted on the conductor member. As a result of this, an antenna 201 taken as one example of an antenna of the present invention includes: a planar (plate-like) antenna element 215 in which an electrically conductive path (line) having a meander shape (meander line antenna shape, meander-shaped part) which is made up of at least one return pattern, more preferably two or more return patterns, is arranged in a two-dimensional manner; and a feed line 221 which is connected to the antenna element 215 (see FIG. 12).

Further, the inventors of the present invention found out that it is more preferable to employ the short-circuit member 231 (short-circuit section) which partially short-circuits the electrically conductive path and to determine a position and a portion to which the short-circuit member 231 is to be provided, in order to increase the number of resonance points in the antenna element 215 and to thus decrease the VSWR value. The use of the short-circuit member 231 allows expansion of a usable band, even in a case where the antenna 201 is mounted on a conductor member.

The antenna element 215 has an electrically conductive path continuing from its one end part to the other end part, and the antenna element 215 is a single line. In view of the fact that the antenna element 215 has the electrically conductive path thus continuing from its one end part to the other end part, it can be said that the antenna element 215 is provided in a loop manner. With the antenna element 215 provided in a loop manner, it is possible to improve a gain of the antenna. Further, the whole antenna element 215 is provided in a single plane. The antenna element 215 can be made from a material such as an electrically conductive wire or an electrically conductive film. Alternatively, the antenna element 215 can be printed wiring.

According to the electrically conductive path of the antenna element 215, a part of the antenna element 215 which part extends from one end part by a predetermined length (i.e., a part corresponding to a wind section 211 which will be described later) and a part of the antenna element 215 which part extends from the other end part by a predetermined length (i.e., a part corresponding to the wind section 211) serve as a first root section 225 and a second root section 226, respectively. In the antenna element 215, a part of the antenna element 215 which part is other than these two root sections 225 and 226 serves as an intermediate section. That is, the intermediate section is a junction between the first root section 225 and the second root section 226.

A part of the intermediate section constitutes the antenna section 212 having a meander shape (meander-shaped part), and some part of the remainder of the intermediate section constitutes a first wider width part 213 and a second wider width part 214. Meanwhile, the aforementioned two root sections 225 and 226 constitute the wind section 211. The first wider width part 213 and the second wider width part 214 share a common area with each other.

In summary, the electrically conductive path runs from its one end part of the antenna element 215 to the other end part in such a manner that the electrically conductive path begins with the first root section 225 and follows with the first wider width part 213, the second wider width part 214, the antenna section 212, and the second root section 226 in this order, and the second root section 226 comes back to a position near the first root section 225.

According to the first root section 225, the electrically conductive path continuing from its one end part to the other end part is drawn out in a leftward direction (i.e., a negative direction of the X axis) of the sheet on which FIG. 12 is shown. According to the second root section 226, the electrically conductive path continuing from the other end part to the one end part is drawn out in a rightward direction (i.e., a positive direction of the X axis) of the sheet on which FIG. 12 is shown. That is, these two directions in which the electrically conductive path is drawn out are opposite to each other.

More specifically, both of the directions in which the respective first and second root sections 225 and 226 extend are rotated by 180 degrees so as to surround a feed section 222.

As such, in either of the following cases: transmission or reception of radio wave on a low frequency band side or transmission or reception of radio wave on a high frequency band side, it is possible to obtain high radiant gains with respect to the respective radio waves.

Further, the direction in which the first root section 225 is drawn out is a direction in which the feed line 221 extends from the feed section 222, which will be described later, to a power-source side, i.e., the leftward direction (i.e., the negative direction of the X axis) of the sheet on which FIG. 12 is shown, whereas the direction in which the second root section 226 is drawn out is a direction opposite to the direction in which the feed line 221 extends.

Specifically, according to the wind section 211, a direction in which the first root section 225 extends from the one end of the antenna element 215 is changed from an upward direction (i.e., a positive direction of the Z axis) of the sheet on which FIG. 12 is shown to a leftward direction (i.e., the negative direction of the X axis, the drawing direction) of the sheet. That is, the first root section 225 has a first linear part 225o1, which extends in the upward direction of the sheet, and a first bending part 225o2 (first tail end linear part), which extends in the leftward direction of the sheet from an end of the first linear part 225o1.

Further, a direction in which the second root section 226 extends from the other end of the antenna element 215 is changed from a downward direction (i.e., a negative direction of the Z axis) of the sheet on which FIG. 12 is shown to a rightward direction (i.e., a positive direction of the X axis, the drawing direction) of the sheet. That is, the second root section 226 has a second linear part 226o1, which extends in the downward direction of the sheet, and a second bending part 226o2 (second tail end linear part), which extends in the rightward direction of the sheet from an end of the second linear part 226o1.

As such, according to the wind section 211, both of the directions in which the respective first and second root sections 225 and 226 extend are oppositely rotated by 90 degrees so as to surround the feed section 222.

The part of the intermediate section of the antenna element 215 has a meander shape made up of at least one return pattern, more preferably two or more return patterns, in the antenna section 212. A return direction (i.e., a positive or negative direction of the Z axis in FIG. 12) of the return pattern in the meander shape is perpendicular to the direction (i.e., the positive direction of the X axis in FIG. 12) in which the second root section 226 is drawn out in the wind section 211, i.e. the direction in which the second bending part 226o2 (tail end linear part) extends.

In the wind section 211, the aforementioned feed section 222 is provided in the two root sections 225 and 226. Each of the root sections 225 and 226 receives power via the feed line 221 connected with the feed section 222.

An arrangement in which the feed line 221 is connected to the feed section 222 is specifically shown in FIG. 25. In this arrangement, an outer electric conductor 122 of a coaxial cable serving as the feed line 221 feeds power to the first root section 225, whereas an inner electric conductor 123 of the coaxial cable feeds power to the second root section 226. There is provided, above the first wider width part 213b, a sheathed part of the coaxial cable. The sheathed part (i) is sheathed in an insulating jacket (i.e., a part where the outer electric conductor 122 is not exposed) and (ii) is adjacent to an exposed part where the outer electric conductor 122 is exposed.

The power is fed in the feed section 222 via the feed line 221 as follows. Specifically, in the feed section 222, (i) a signal, having a frequency which falls within a predetermined frequency band, is applied to the second root section 226 via the inner electric conductor 123 of the coaxial cable, and (ii) an earth electric potential is applied to the first root section 225 via the outer electric conductor 122 of the coaxial cable.

Further, the first wider width part 213, which lies below the feed line 221 and overlaps the feed line 221, has a line width (the length in the X axis direction) wider than a line width of a part that constitutes the wind section 211 and the antenna section 212 of the antenna element 215. This allows the feed section 222 to realize an impedance matching between the antenna element 215 and the feed line 221.

As is the case with the first wider width part 213, a line width of the second wider width part 214 is wider than the line width of the part that constitutes the wind section 211 and the antenna section 212 of the antenna element 215.

Unlike the case of FIG. 12, in a case where the feed line 221 extends in the negative direction of the Z axis from the feed section 222, the second wider width part 214 plays a role of the first wider width part 213. That is, it can be said that the line width (the length in the Z axis direction) of the second wider width part 214, which lies below the feed line 221 and overlaps the feed line 221, is wider than the line width of the part that constitutes the wind section 211 and the antenna section 212.

Note that the antenna 201 has, for example, the following size: a length in a crosswise direction (i.e., X axis direction) of the sheet on which FIG. 12 is shown is 92 mm; and a length in a lengthwise direction (i.e., Z axis direction) of the sheet is 52 mm.

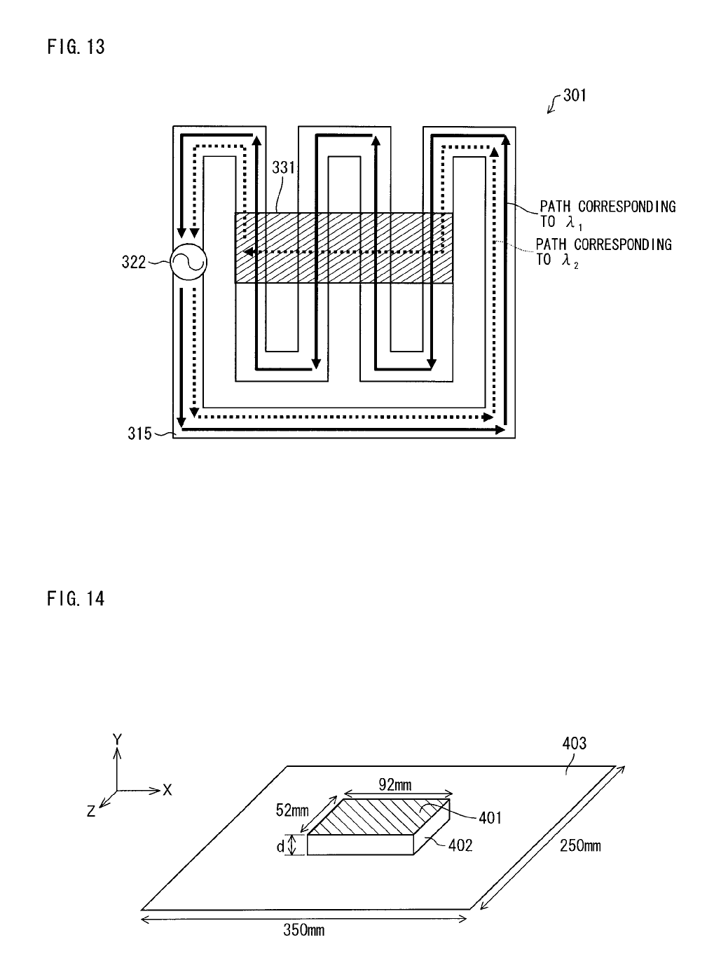

Further, in the meander shape of the antenna section 212, there is provided a short-circuit member 231. The following description discusses the role of the short-circuit member 231 with reference to FIG. 13.

(Role of the Short-Circuit Member 231)

FIG. 13 is a view schematically illustrating a state in which a short-circuit member 331 is provided in an antenna element 315 having a meander shape, thereby a plurality of electrically conductive paths are formed in the antenna element 315.

As illustrated in FIG. 13, an antenna 301 includes: the antenna element 315 which is a single path; and a feed line. The antenna element 315 has a meander shape (meander structure). That is, the antenna element 315 is meandered. A feed section 322 of the antenna element 315 is connected with the feed line.

The short-circuit member 331 short-circuits for example two or more different points (a plurality of points) in the meandered antenna element 315. According to an example shown in FIG. 13, a short circuit is caused between two linear parts extending in respective upward and downward directions, which two linear parts are located in both end parts of the short-circuit member 331. This causes a first path (first electrically conductive path) and a second path (second electrically conductive path) to be formed. The first path corresponds to a first wavelength λ1 and is plotted in solid line, and the second path corresponds to a second wavelength λ2 and is plotted in dotted line.

As described above, according to the antenna 301, the short-circuit member 331 is provided to the meandered antenna element 315 so as to short-circuit a plurality of different points, to thereby increase the number of electrically conductive paths having different lengths. This makes it possible to increase the number of resonance frequencies (resonance points) of the antenna 301, and thus possible to improve the VSWR characteristics of the antenna 301 in a usable band.

It should be noted here that, as described earlier, when an antenna is mounted on a conductor member, the antenna may deteriorate in VSWR characteristics (increase in a VSWR value) in a usable band due to an effect of the conductor member. The usable band is for example 470 MHz to 770 MHz in a case of an antenna for terrestrial digital broadcasting in Japan, 470 MHz to 860 MHz in a case of an antenna for terrestrial digital broadcasting in North America, and 470 MHz to 890 MHz in a case of an antenna for terrestrial digital broadcasting in Europe.

In such a case, as described with reference to the antenna 301 shown in FIG. 13, it is possible to suppress a deterioration in VSWR characteristics (increase in VSWR value) in the usable band by providing the short-circuit member 331 to the meandered antenna element 315 so as to short-circuit a plurality of different points. That is, in view of the effect of the conductor member, where in the antenna element 315 the short-circuit member 331 is to be provided so as to cause a short circuit is determined under a condition where there is a dummy conductor member near the antenna element 315. This increases the number of electrically conductive paths having different lengths, and thus increases the number of resonance frequencies of the antenna 301. As a result, it is possible to suppress a deterioration in VSWR characteristics (increase in VSWR value) in the usable band which deterioration is caused by an effect of a conductor member, even when the antenna 301 is mounted on the conductor member.

According to the antenna 201 shown in FIG. 12, the short-circuit member 231 which serves as the foregoing short-circuit member 331 is provided in the meandered antenna section 212. A position and a portion in which the short-circuit member 231 is to be provided are determined for example in the following manner.

Where to provide the short-circuit member 231 is determined so that, under a condition where the antenna element 215 is provided on a metal plate via a dielectric material, a VSWR value in each frequency in the usable band becomes less than a VSWR value obtained in a case where no short-circuit member 231 is provided. It is more preferable that where to provide the short-circuit member 231 be determined so that, under a condition where the antenna element 215 is provided on a metal plate via a dielectric material, the VSWR value in each frequency in the usable band becomes not more than 3.5.

More specifically, the short-circuit member 231 is temporarily placed on the antenna element 215 which is provided via a dielectric material on a dummy metal plate, and then the short-circuit member 231 is moved while the VSWR value in the usable band is being monitored. If a position is found in which the VSWR value in each frequency in the usable band is less than the VSWR value obtained in the case where no short-circuit member is provided, then the short-circuit member 231 is fixed to that position. On the other hand, if no position is found in which the VSWR value in each frequency in the usable band is less than the VSWR value obtained in the case where no short-circuit member is provided, then the short-circuit member 231 is replaced with another short-circuit member 231 having a different shape or a different size and then the above trial is repeated.

The short-circuit member 231 is the one that causes a short circuit between predetermined points in the antenna element 215, and can be made for example from a conductive material such as metal. The short-circuit member 231 for example makes direct contact with the antenna element 215 to thereby cause a short circuit in the antenna element 215.

The following description discusses the results of experiments for examining how the presence of the short-circuit member 231 is related to VSWR characteristics.

(Effect of Presence of Short-Circuit Member)

In this experiment, an antenna device 401 was provided by mounting an antenna via a dielectric layer 402 on a metal plate 403 which is 350 mm×250 mm in size and which serves as a conductor member (see FIG. 14). The dielectric layer 402 will be described later. It should be noted that, provided that the antenna device 401 is approximately 100 mm×50 mm in size, it is possible to achieve substantially the same characteristics as in the case where the antenna device 401 is mounted on a conductor member of 350 mm×250 mm in size even when the antenna device 401 is mounted on a conductor member such as a hood of an automobile.

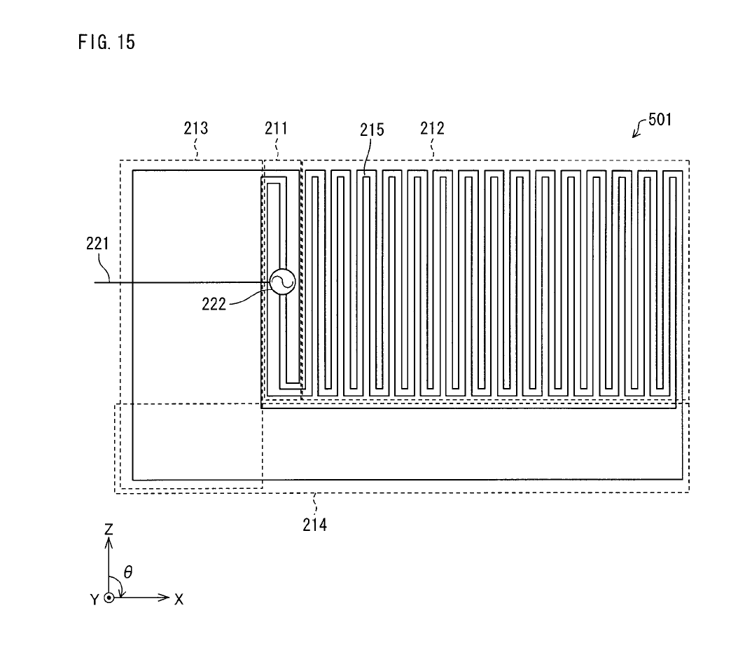

The antenna 201 shown in FIG. 12 and an antenna 501 shown in FIG. 15 were each used as the antenna device 401. The VSWR characteristic of each of these antenna devices was measured. Note that the antenna 501 shown in FIG. 15 has the same configuration as that of the antenna 201 shown in FIG. 12 except that the short-circuit member 231 provided in the antenna 201 shown in FIG. 12 is not provided in the antenna 501.

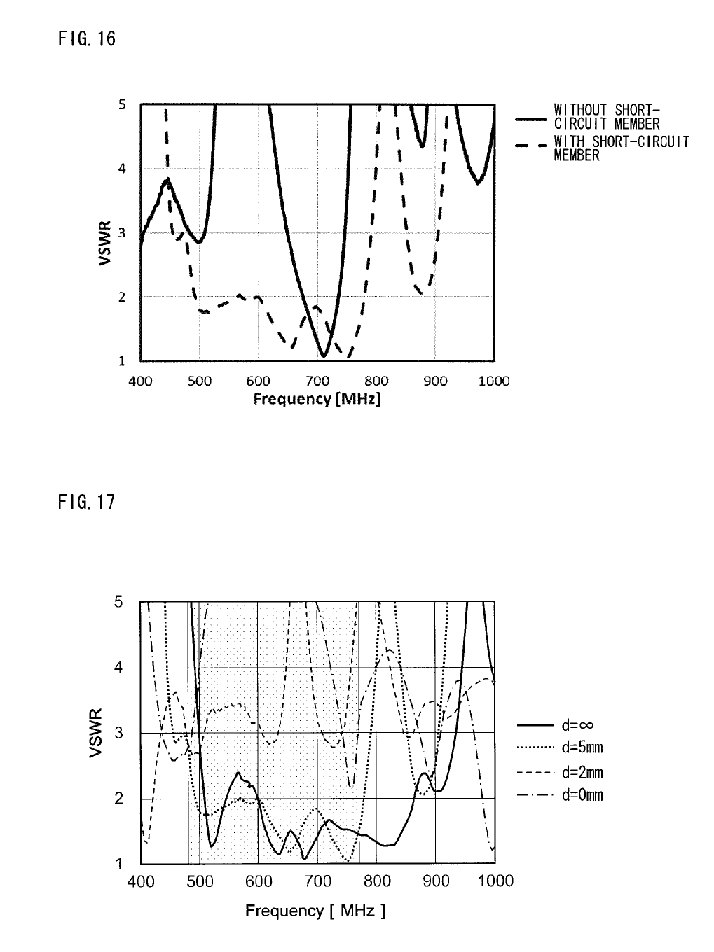

FIG. 16 is a graph illustrating the results of measurement of the VSWR characteristics of the antenna 201 and of the antenna 501. In FIG. 16, a graph indicated by “WITH SHORT-CIRCUIT MEMBER” represents the result of measurement of the antenna 201, and a graph indicated by “WITHOUT SHORT-CIRCUIT MEMBER” represents the result of measurement of the antenna 501. It should be noted that, during the measurement, the thickness d of the dielectric layer 402 was 5 mm and the specific inductive capacity ∈ᵣ of the dielectric layer 402 was 1.

As is clear from the experimental results shown in FIG. 16, it is possible to prevent the VSWR from being greater than 3.5 in a band of not more than 800 MHz, i.e., in the terrestrial digital television band (470 MHz to 770 MHz), by providing the short-circuit member 231 to the antenna 201 so as to cause a short-circuit.

Meanwhile, the antenna 501 can prevent the VSWR from being greater than 3.5 in a frequency band of approximately 650 MHz to 750 MHz, thus enabling excellent transmission and reception in such a frequency band. This can be considered as the effect achieved by the arrangement of the antenna 501 in which the antenna element 215 having a meander-shaped electrically conductive path is provided.

In the case of the antenna 501, excellent VSWR characteristics were achieved in the frequency band of approximately 650 MHz to 750 MHz. This result is merely an example. That is, by design changes to the meander shape, frequency band values and ranges that satisfy the VSWR of not greater than 3.5 can be changed in various ways. Therefore, depending upon a usable frequency band, the short-circuit member may be eliminated.

Although the descriptions in the present embodiment have discussed the case where a plurality of points adjacent to each other in a single plane are short-circuited, a plurality of points which are not adjacent to each other may be short-circuited. For example, points may be short-circuited by a short-circuit member which is not of a linear shape. Alternatively, two or more points being away from one another may be short-circuited by an interlayer conduction achieved by a double-layered structure such that a short-circuit member is provided on a plane which is different from the plane where the antenna 201 is provided.

As described above, the inventors of the present invention found that it is more preferable that by determining a position and a portion to which the short-circuit member 231 is to be provided, the number of resonance points in the antenna element 215 was increased and thus the VSWR value is decreased. The use of the short-circuit member 231 allows expansion of a usable band, even in a case where the antenna 201 is mounted on a conductor member.

(Effect of Thickness of Dielectric Material)

The inventors have found that, by providing the dielectric layer 402 between the antenna device 401 and the metal plate 403 serving as a conductor member, it is possible to achieve an antenna device having a practical VSWR characteristic even when a distance between the antenna device 401 and the conductor member (metal plate 403) is reduced to approximately several millimeters (see FIG. 14). In this case, it is preferable to set the specific inductive capacity ∈ᵣ of the dielectric layer 402 to be not less than 1 but not greater than 10. This is because the specific inductive capacity ∈ᵣ of greater than 10 makes a radiant efficiency reduction unignorable.

FIG. 17 illustrates the results, for each thickness d of the dielectric layer 402, obtained by measuring the VSWR characteristic of the antenna device 401 while changing the thickness d. Note here that the antenna device 401 used here is the antenna 201 shown in FIG. 12.

Further, the thickness d was changed to the following four thicknesses: d=Infinite (∞), d=5 mm, d=2 mm, and d=0 mm. Note that d=Infinite means that the distance between the antenna 201 and the metal plate 403 is infinite, i.e., no metal plate 403 is present. Further, d=0 mm means that the antenna 201 is mounted so as to be in contact with the metal plate 403 via an insulating member that is as thin as possible, such as an insulating film. That is, d=0 mm means that the antenna 201 and the metal plate 403 are close to each other as much as possible while a conductor part of the antenna 201 and the metal plate 403 are not in direct contact with each other and electrical isolation between the conductor part of the antenna 201 and the metal plate 403 is maintained.

It is clear from FIG. 17 that, when d=Infinite or d=5 mm, it is possible to prevent the VSWR from being greater than 3.5 in a band of 470 MHz to 770 MHz. Further, even when d=2 mm, it is possible to prevent the VSWR from being greater than 3.5 in the band of 470 MHz to 770 MHz except for a band in the vicinity of 670 MHz. This implies the following.

When d=Infinite, that is, when the antenna 201 is not mounted on the metal plate 403, the antenna 201 is not affected by the metal plate 403. In other words, when the distance between the antenna 201 and the metal plate 403 is gradually reduced from infinite, the antenna 201 should become affected by the metal plate 403 more strongly as it approaches the metal plate 403.

That is, the results in FIG. 17 show that, by causing the thickness d of the dielectric layer 402 between the antenna 201 and the metal plate 403 to be equal to or greater than 5 mm, i.e., by causing the distance between the antenna 201 and the metal plate 403 to be equal to or greater than 5 mm, it is possible to prevent the VSWR from being greater than 3.5 in the band of 470 MHz to 770 MHz. Further, the results show that, by causing the distance between the antenna 201 and the metal plate 403 to be equal to or greater than 2 mm, it is possible to prevent the VSWR from being greater than 3.5 in the band of 470 MHz to 770 MHz, except for some band(s).

Note that FIG. 17 shows a characteristic obtained in a case where an antenna base material having a specific inductive capacity ∈ᵣ of approximately 2 to 3 and a thickness of 1 mm or less is used, and a separation distance, excluding a thickness of the base material, between the antenna 201 (the base material) and the metal plate 403, i.e. a thickness d of the dielectric layer 402 is provided by use of a material (styrene foam etc.) having a specific inductive capacity ∈ᵣ of approximately 1.

Therefore, according to the characteristic shown in FIG. 17, the VSWR deteriorates in the vicinity of 670 MHz when the thickness d=2 mm. However, according to the present invention, the VSWR in the vicinity of 670 MHz does not necessarily deteriorate. This is because the characteristic shown in FIG. 17 can be adjusted by optimizing, for example, a short-circuit member and/or a meander shape, the specific inductive capacity ∈ᵣ and the thickness of the antenna base material, and/or the specific inductive capacity ∈ᵣ of the dielectric layer 402.

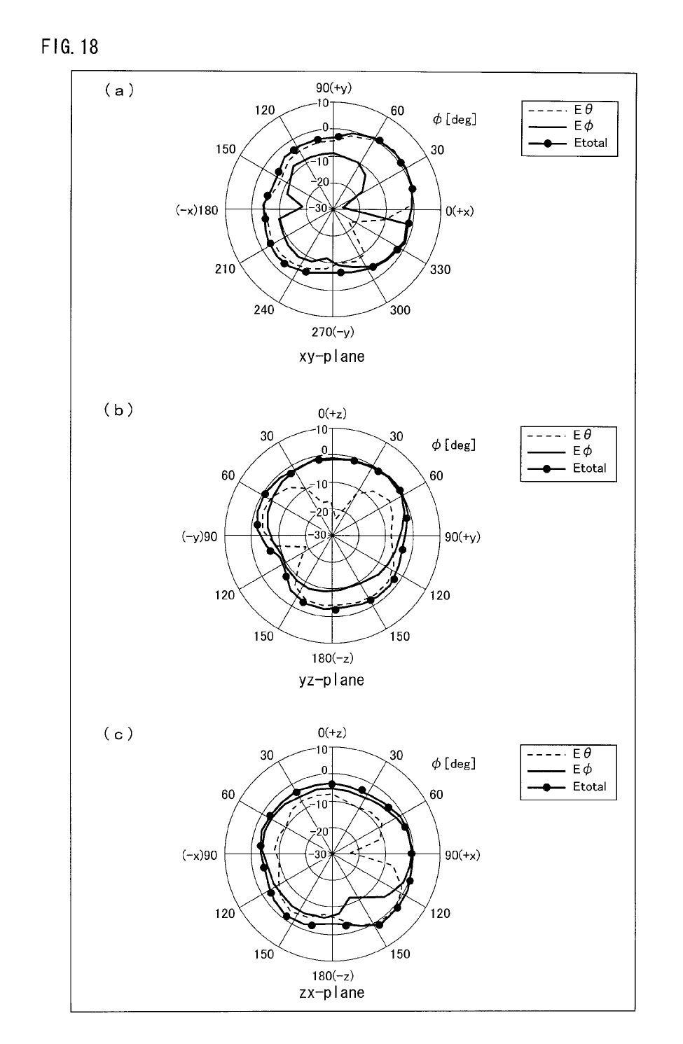

FIG. 18 shows graphs each illustrating radiation patterns in a 550 MHz band of the antenna 201 shown in FIG. 12. (a) of FIG. 18 illustrates an in-xy-plane radiation pattern in an xyz coordinate system shown in FIG. 14. (b) of FIG. 18 illustrates an in-yz-plane radiation pattern. (c) of FIG. 18 illustrates an in-zx-plane radiation pattern. Note here that the thickness d of the dielectric layer 402 was 5 mm and the specific inductive capacity ∈ᵣ of the dielectric layer 402 was 1. Note also that in FIG. 18, Eθ indicates radiation power of the antenna with respect to a vertical polarized wave V, Eφ indicates radiation power of the antenna with respect to a horizontal polarized wave H, and Etotal indicates total radiation power of the antenna.

It is clear from FIG. 18 that a non-directivity radiation characteristic is achieved in all the in-xy-plane radiation pattern, the in-yz-plane radiation pattern, and the in-zx-plane radiation pattern.

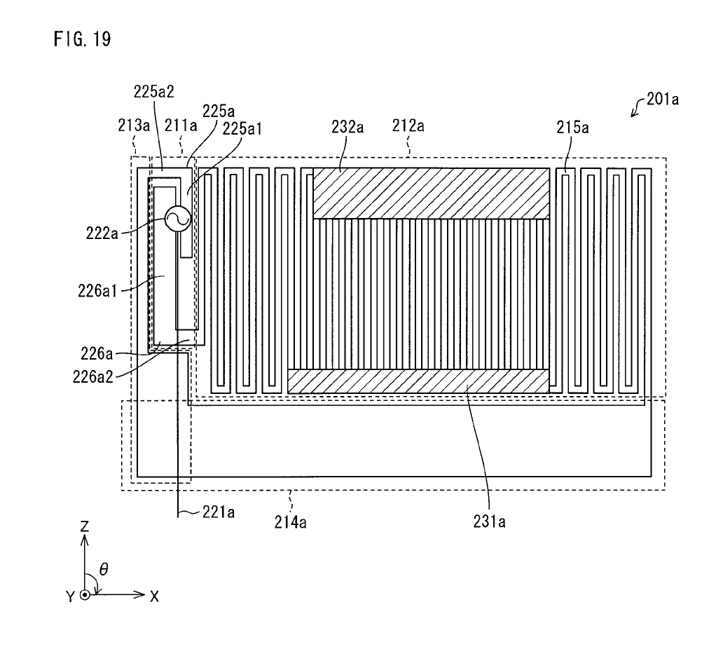

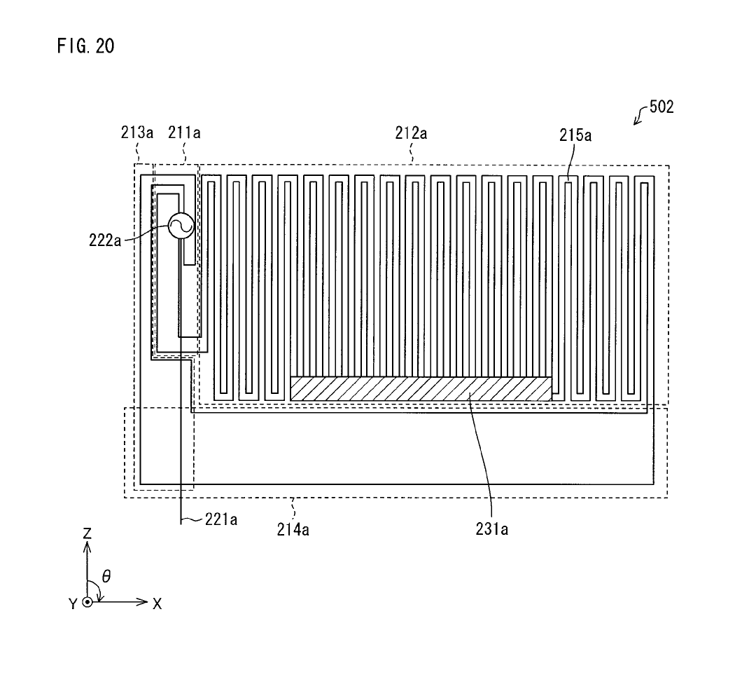

FIG. 19 illustrates an antenna 201a, which is a modified example of the antenna 201. The following description discusses in detail differences between the modified example and the antenna 201. Descriptions for the same parts are omitted here.

The antenna 201a has the following size: a length in a crosswise direction of a sheet on which FIG. 19 is illustrated (i.e., X axis direction) is 83 mm; and a length in a lengthwise direction of the sheet (i.e., Z axis direction) is 56 mm.

In a wind section 211a, a feed section 222a are respectively provided in two root sections 225a and 226a of an antenna element 215a. Each of the two root sections 225a and 226a receives power via a feed line 221a connected with the feed section 222a.

The first root section 225a has a first linear part 225a1 and a first bending part 225a2 (first tail end linear part). The first linear part 225a1 and the first bending part 225a2 correspond to the first linear part 225o1 and the first bending part 225o2 of the first root section 225 shown in FIG. 12, respectively. Similarly, the second root section 226a has a second linear part 226a1 and a second bending part 226a2 (second tail end linear part). The second linear part 226a1 and the second bending part 226a2 correspond to the second linear part 226o1 and the second bending part 226o2 of the second root section 226 shown in FIG. 12, respectively.

The feed line 221a extends from the feed section 222a in the negative direction of the Z axis in the sheet on which FIG. 19 is illustrated, which direction is different from the direction in which the feed line 221 of Embodiment 1 extends.

Accordingly, a direction in which each of the two root sections 225a and 226a is drawn out is (i) perpendicular to the direction in which the feed line 221 extends in FIG. 12, and is also (ii) parallel to the direction in which the feed line 221a extends.

Further, a line width (the length in the X axis direction) of a portion of a first wider width part 213a, which portion is provided below the feed line 221a and overlaps the feed line 221a, is wider than a line width of a part that constitutes the wind section 211a and the antenna section 212a.

The feed line 221a may extend in the negative direction of the X axis from the feed section 222a, which direction is different from that shown in FIG. 19.

Further, a short-circuit member 231a and a short-circuit member 232a are provided in a meander shape of the antenna section 212a. The roles of the short-circuit members 231a and 232a are the same as those of the short-circuit member 231.

Next, the inventors of the present invention conducted an experiment aiming to determine an extent to which the VSWR characteristic improves depending upon the presence or absence of the short-circuit members 231a and 232a.

(Effect of Presence of Short-Circuit Member)

In the same manner as the antenna 201, the inventors mounted an antenna device 401 via a dielectric layer 402 on a metal plate 403 which is 350 mm×250 mm in size (see FIG. 14).

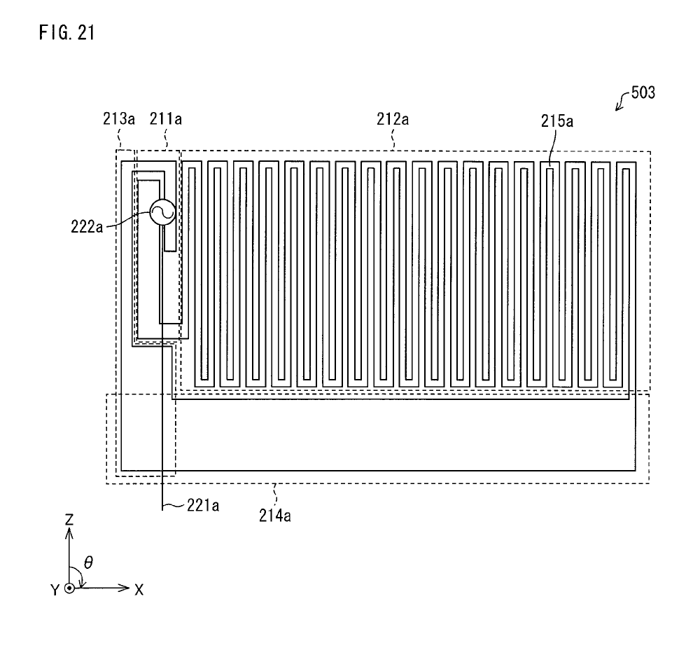

The antenna 201a shown in FIG. 19, an antenna 502 shown in FIG. 20 and an antenna 503 shown in FIG. 21 were each used as the antenna device 401. The VSWR characteristic of each of these antennas was measured. The antenna 502 shown in FIG. 20 has the same configuration as that of the antenna 201a shown in FIG. 19, except that the short-circuit member 232a shown in FIG. 19 is not provided in the meander-shaped part of the antenna section 212a. Further, the antenna 503 shown in FIG. 21 has the same configuration as that of the antenna 201a shown in FIG. 19, except that neither the short-circuit member 231a nor the short-circuit member 232a shown in FIG. 19 is provided in the meander-shaped part of the antenna section 212a.

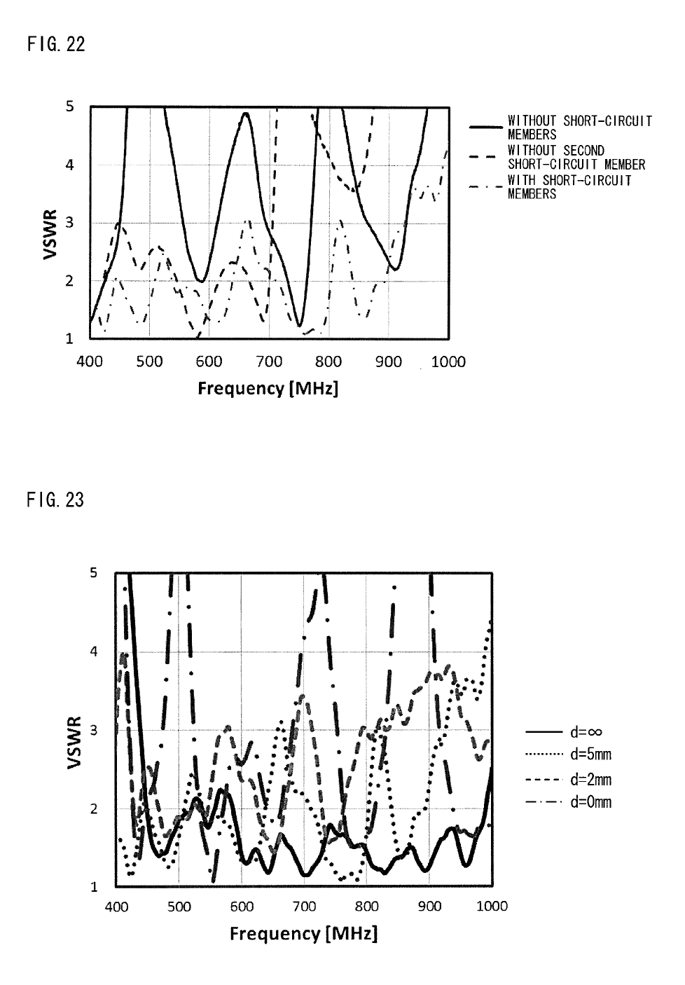

FIG. 22 illustrates results obtained by measuring the VSWR characteristics of the antenna 201a, the antenna 502 and the antenna 503. In FIG. 22, a graph indicated by the “WITH SHORT-CIRCUIT MEMBERS” represents the result for the antenna 201a, a graph indicated by the “WITHOUT SHORT-CIRCUIT MEMBERS” represents the result for the antenna 503, and a graph indicated by the “WITHOUT SECOND SHORT-CIRCUIT MEMBER” represents the result for the antenna 502. It should be noted that, during the measurement, the thickness d of the dielectric layer 402 was 5 mm and the specific inductive capacity ∈ᵣ of the dielectric layer 402 was 1.

As is clear from the graph indicated by the “WITHOUT SECOND SHORT-CIRCUIT MEMBER” in FIG. 22, first, it is possible to prevent the VSWR from being greater than 3.5 in a low-frequency band, out of the terrestrial digital television band (470 MHz to 770 MHz), by providing the short-circuit member 231a to thereby cause a short circuit.

Further, it is clear from the graph indicated by the “WITH SHORT-CIRCUIT MEMBERS” that it is possible to prevent the VSWR from being greater than 3.5 also in a high-frequency band, out of the terrestrial digital television band (470 MHz to 770 MHz), by further providing the short-circuit member 232a to thereby cause a short circuit.

Note, however, that, as is clear from the graph indicated by “WITHOUT SHORT-CIRCUIT MEMBERS”, the antenna 503 prevents the VSWR from being greater than 3.5 in the frequency band of approximately 550 MHz to 620 MHz and the frequency band of approximately 680 MHz to 770 MHz (described earlier), thus enabling excellent transmission and reception in such frequency bands. This can be considered as the effect achieved by the arrangement of the antenna 503 in which the antenna element 215a having a meander-shaped electrically conductive path is provided. Therefore, depending upon a usable frequency band, the number of short-circuit members can be changed to any number including 0 (zero).

(Effect of Thickness of Dielectric Material)

FIG. 23 illustrates the results, for each thickness d of the dielectric layer 402, obtained by measuring the VSWR characteristic of the antenna device 401 while changing the thickness d. Note here that the antenna device 401 used here is the antenna 201a shown in FIG. 19.

Further, the thickness d was changed to the following four thicknesses: d=Infinite (∞), d=5 mm, d=2 mm, and d=0 mm.

It is clear from FIG. 23 that, when d=Infinite or d=5 mm, it is possible to prevent the VSWR from being greater than 3.1 in a band of 420 MHz to 920 MHz.

Further, it is clear from FIG. 23 that, when d=Infinite, d=5 mm, or d=2 mm, it is possible to prevent the VSWR from being greater than 3.5 in a band of 420 MHz to 870 MHz.

These results show that, by causing the distance between the antenna 201a and the metal plate 403 to be equal to or larger than 2 mm, it is possible to prevent the VSWR from being greater than 3.5 in the band of 420 MHz to 870 MHz.

Note here that FIG. 23 shows a characteristic obtained in a case where an antenna base material having a specific inductive capacity ∈ᵣ of approximately 2 to 3 and a thickness of 1 mm or less is used, and a separation distance, excluding a thickness of the base material, between the antenna 201a (the base material) and the metal plate 403, i.e. a thickness d of the dielectric layer 402 is provided by use of a material (styrene foam etc.) having a specific inductive capacity ∈ᵣ of approximately 1.

Note that, also when d=0 mm, the VSWR is prevented from being greater than 3.5 in, for example, a frequency band in the vicinity of 450 MHz, a frequency band of approximately 520 MHz to 690 MHz, and a frequency band of approximately 750 MHz to 830 MHz, thus enabling excellent transmission and reception in such frequency bands. Therefore, in a case where a usable frequency band may be limited to a specific frequency band, the antenna of the present invention in which the antenna element having a meander shape is provided can be placed as close as to a conductor while being insulated from a surface of the conductor.

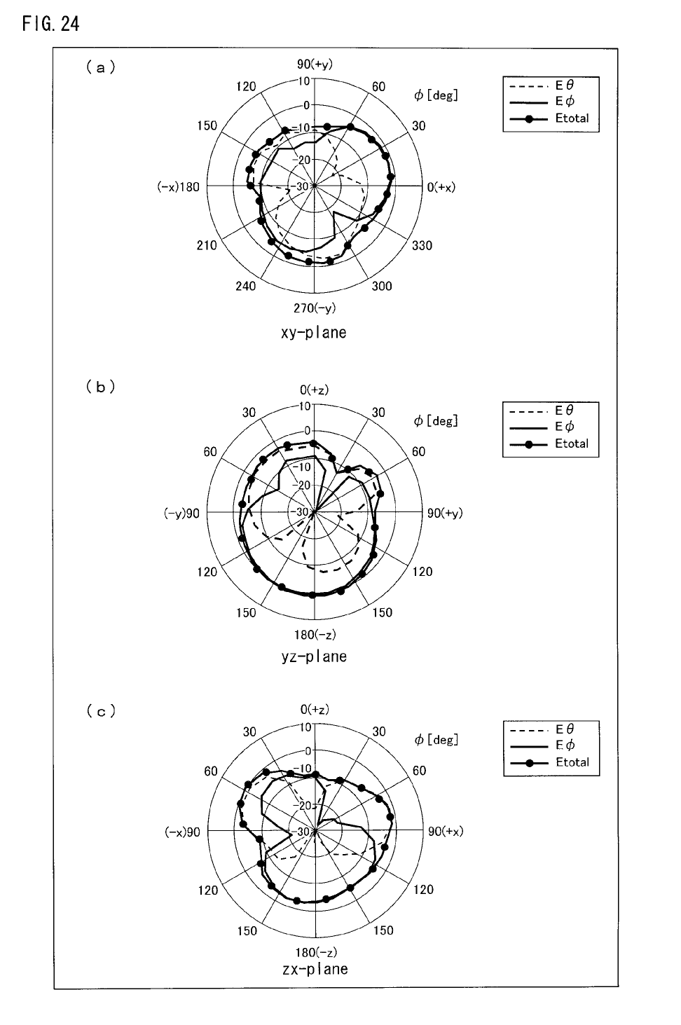

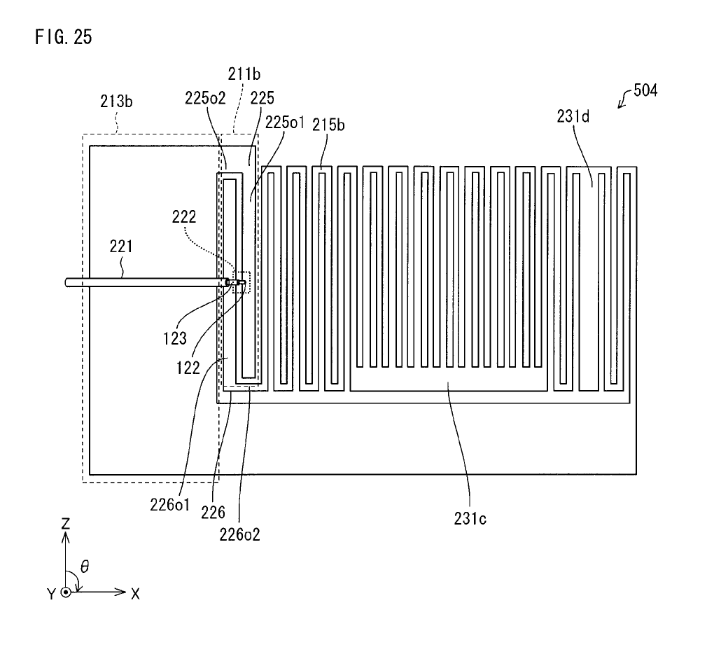

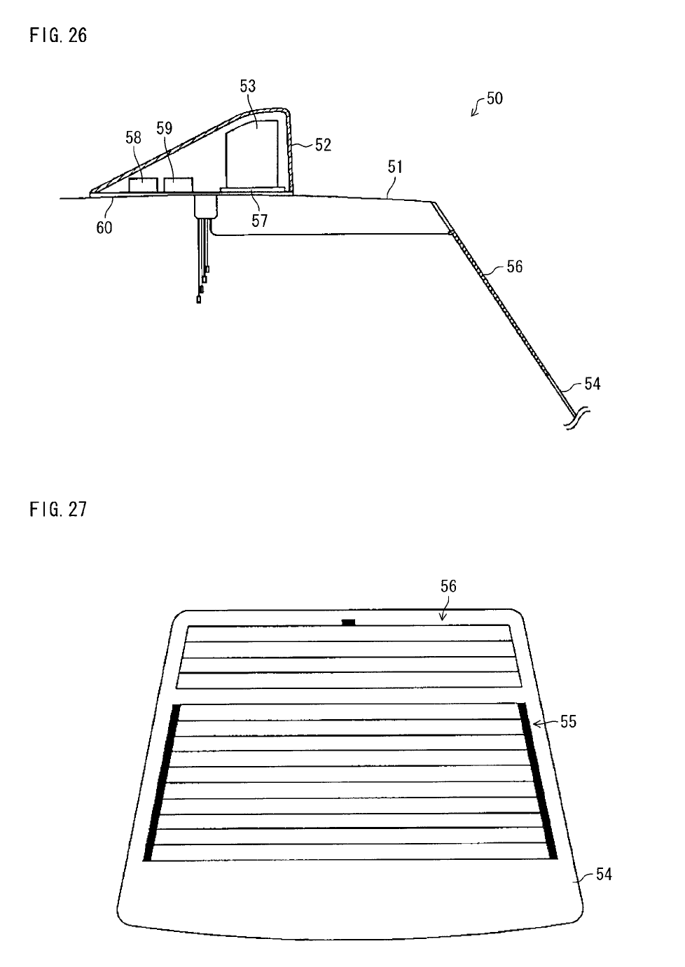

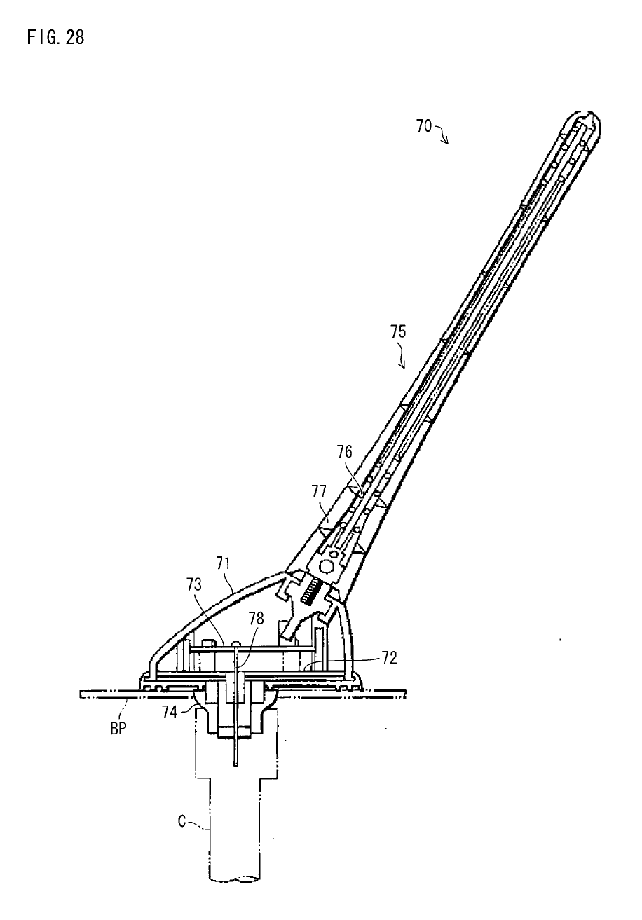

FIG. 24 shows graphs each illustrating radiation patterns in a 550 MHz band of the antenna 201a shown in FIG. 19. (a) of FIG. 24 illustrates an in-xy-plane radiation pattern in the xyz coordinate system shown in FIG. 14. (b) of FIG. 24 illustrates an in-yz-plane radiation pattern. (c) of FIG. 24 illustrates an in-zx-plane radiation pattern. Note here that the thickness d of the dielectric layer 402 was 5 mm and the specific inductive capacity ∈ᵣ of the dielectric layer 402 was 1.

It is clear from FIG. 24 that a non-directivity radiation characteristic is achieved in all the in-xy-plane radiation pattern, the in-yz-plane radiation pattern, and the in-zx-plane radiation pattern.

### Modified Example

FIG. 25 illustrates an antenna 504 which is a modified example of the antenna 201 shown in FIG. 12. The following will describe details of differences from the antenna 201, and descriptions of the same parts as the antenna 201 will be omitted.

According to the antenna 504, the lengths of a first wider width part 213b and a wind section 211b which lengths extend in the positive direction of the Z axis are larger than those of the first wider width part 213 and the wind section 211 of the antenna 201. As such, upper end parts of the first wider width part 213b and a wind section 211b which parts present on a side of the positive direction of the Z axis are protruded, toward the positive direction of the Z axis, from the position of the upper end part of the antenna element 215 which part presents on a side of the positive direction of the Z axis.

While the antenna 201 includes the short-circuit member 231 which is provided as an independent member, the antenna 504 includes a short-circuit section 231c which is provided in a lower end part of the antenna element 215 which part presents on a side of the negative direction of the Z axis. The short-circuit section 231c is made from the same material as that of the electrically conductive path forming the antenna element 215b and is also integrated with an electrically conductive path. Further, the short-circuit section 231d is folded back along the Z axis and is formed by integration of two electrically conductive paths provided side by side. Moreover, a width of the short-circuit section 231d along the X axis direction is almost three times larger than the width of one electrically conductive path. It is needless to say that the number of side-by-side electrically conductive paths to be integrated may be adjusted as appropriate so that excellent VSWR characteristics can be obtained. Similarly, the length of the short-circuit section 231c along the X axis direction can be adjusted as appropriate.

In this manner, the short-circuit member is not provided as an independent member, but is formed from the same material as that of the electrically conductive path so as to be integral with electrically conductive path. This makes it possible to concurrently form the electrically conductive path and the short-circuit member, thus simplifying a manufacturing process.

### SUMMARY

As described above, a movable body according to the present invention includes: (1) a plate-like antenna element having an electrically conductive path arranged in a two-dimensional manner; (2) a feed line connected to the antenna element; and (3) a support, while causing the antenna element to be spaced away from an electrically conductive material layer of an outer shell of a movable body, holding the plate-like antenna element in such a manner as to conform to a front surface or a back surface of the outer shell, (4) the plate-like antenna element including: (i) a first root section being a part of the antenna element which part extends from one end part of the electrically conductive path by a predetermined length; (ii) a second root section being a part of the antenna element which part extends from the other end part of the electrically conductive path by a predetermined length; and (iii) an intermediate section which is a junction between the first root section and the second root section, (5) the first and second root sections having first and second feed sections respectively provided therein, the first and second feed sections being each connected to the feed line, (6) the intermediate section having the electrically conductive path provided therein, the electrically conductive path having a meander shape with a return pattern, and (7) the support being made from a dielectric material.

The inventors of the present application have diligently studied and found out that even in a case where the antenna including the features (1) and (2) and being employed as an antenna of an antenna device, wherein the antenna element in the feature (1) has the features (4) through (6), is installed in such a manner that the antenna conforms to the front surface or the back surface of the outer shell (exterior material) of the movable body, the outer shell containing an electrically conductive material layer, i.e. in such a manner that the antenna conforms to an exterior-side surface of the outer shell or a cabin-side surface of the outer shell of the movable body, a frequency band can be presented in which the antenna device is capable of achieving an excellent sensitivity and a non-directivity and improving the VSWR characteristics. Note that the antenna device of the present invention may be any of the following antennas: a transmission and reception-capable antenna device, a transmission-dedicated antenna device, and reception-dedicated antenna device.

Further, the inventors of the present application found out that when a support made from a dielectric material holds the antenna element, while causing the antenna element to be spaced from the front surface or the back surface of the outer shell, in such a state so as to conform to the front surface or the back surface of the outer shell, an adverse effect of the electrically conductive material layer is prevented, and a frequency band in which excellent VSWR characteristics are exhibited expands.

Therefore, according to the present invention, it is possible to install a low-profile antenna device having excellent characteristics that are a high sensitivity and a non-directivity on a front surface or a back surface of an outer shell containing an electrically conductive material layer in a movable body.

The following will describe, in particular, a case where the antenna device is installed on the back surface of the outer shell, i.e. on the cabin-side (interior-side) surface of the outer shell of the movable body which is, for example, an automobile. Even in a narrow space formed between an interior material on the cabin side and a metal plate of a door, a roof, a pillar, or the like of the automobile, the antenna device can be easily installed on the back surface of the outer shell while conforming to the back surface of the outer shell, in such a state that the plate-like antenna element of the present invention is spaced away from the back surface of the outer shell. Even when the antenna device is installed in such a narrow space, the antenna device can exhibit excellent characteristics that are a high sensitivity and a non-directivity.

Therefore, the antenna device of the present invention also has an advantage in that the antenna device has a high degree of freedom in installation on the outer shell of the movable body.

In a case where the antenna element is spaced away from the front surface or the back surface of the outer shell, there may exist an air layer serving as a dielectric material layer between the antenna and the front or back surface of the outer shell. Alternatively, the air layer may be replaced by a solid dielectric material layer.

In the arrangement in which the air layer lies between the antenna element and the outer shell, the support takes a form of a spacer locally provided between the antenna element and the front or back surface of the outer shell. Meanwhile, in the arrangement in which the solid dielectric material layer lies between the antenna element and the outer shell, the dielectric material layer itself takes a form of the support.

Alternatively, in the arrangement in which the air layer lies between the antenna element and the surface of the outer shell, the support may take a form of a cover member of the antenna device or a cover member which covers a part of the outer shell.

The antenna device according to the foregoing embodiments is preferably arranged such that the plate-like antenna element is provided with a short-circuit section for short-circuiting the electrically conductive path having the meander shape.

This increases the number of electrically conductive paths of varying lengths, thus increasing the number of resonance points in the antenna. This makes it possible to further expand a frequency band usable by the antenna device.

In this case, in placing one or more short-circuit sections for causing a short-circuit(s) on the electrically conductive path having the meander shape, it is possible to determine a position and a portion to which the short-circuit section is to be provided, in order to increase the number of resonance points in the antenna or in order to decrease a VSWR value in a usable band while increasing the number of resonance points in the antenna.

The antenna device according to the foregoing embodiments may be arranged such that the plate-like antenna element is configured such that: the first and second root sections constitute a wind section surrounding the feed sections; and at least one of the first and second root sections has a wider width part of the electrically conductive path, the wider width part being formed such that a portion that overlaps the feed line connected with the feed section is larger in width than other portions.

This allows the feed section to achieve an impedance matching between the antenna element and the feed line. This makes it possible to decrease the VSWR value of the antenna, i.e. to further improve the VSWR characteristics.

As such, it is possible to improve the VSWR characteristics of the antenna while achieving a high radiant gain of the antenna. This makes it possible to further expand a frequency band usable by the antenna device.

The antenna device according to the foregoing embodiments is configured such that the plate-like antenna element is a single line continuing from its one end part to the other end part.

With this arrangement, since the feed sections are provided respectively in both end parts of the antenna element which has the electrically conductive path continuing from the one end part to the other end part, the antenna device makes it possible to realize high radiant gain as is the case with a loop antenna device having a loop shape.

The antenna device according to the foregoing embodiments is preferably arranged such that the antenna element is spaced at a distance of at least 2 mm away from the front surface or the back surface of the outer shell.

With this arrangement, even in a case where the antenna device is mounted in the vicinity of a conductor, it is possible to present a usable frequency band where the VSWR value is prevented from being greater than 3.5.

The antenna device according to the foregoing embodiments may be configured to further include: fixing means for fixing the support onto the outer shell, wherein the support is a plate-like base member, and the antenna element is fixed on a surface of the base member while conforming to the surface of the base member.

The phrase “while conforming to the surface of the base member” may be translated into “in such a manner that the antenna element spreads two-dimensionally or three-dimensionally, as in a two-dimensionally or three-dimensionally spreading manner of the base member.”

This allows the base member to lie, as a dielectric material layer, between the antenna element and the outer shell. As such, in a case where the antenna device is provided on a metallic member of, for example, a body of an automobile, the dielectric material layer can prevent the antenna device from suffering from an adverse effect of the metallic member. This allows the antenna device to maintain excellent VSWR characteristics.

The antenna device according to the foregoing embodiments may be configured to further include: fixing means for fixing the support onto the outer shell, wherein the support is a cover member which covers a part of the surface of the outer shell therewith, the cover member forms a space between an inner wall thereof and the surface of the outer shell, and the plate-like antenna element is fixed on a surface of the inner wall of the cover member while conforming to the surface of the inner wall of the cover member.

With this arrangement, in a case where the antenna device is installed on the surface of the outer shell of the movable body, the cover member, which is indispensable from the viewpoints of waterproofness, protection, and others, can be effectively utilized as the support preventing the antenna device from suffering from adverse effect of the electrically conductive material layer.

In such an arrangement, the air layer lies, as a dielectric material layer, between the antenna element and the outer shell. This allows the antenna device to maintain excellent VSWR characteristics.

The antenna device according to the foregoing embodiments may be arranged such that the plate-like antenna element includes a bow-shaped part having a curvature. In this case, the bow-shaped part has a curvature radius of 5 mm or greater.

As described above, when the antenna element is placed on the curved surface having a curvature radius of 5 mm or greater while the antenna element conforms to the curved surface, the antenna device can maintain excellent characteristics.

The antenna device according to the foregoing embodiments may be arranged to further include: a transmitting and receiving circuit which is connected to the plate-like antenna element via the feed line, wherein the plate-like antenna element and the transmitting and receiving circuit are provided in a single plane.

This makes it possible to achieve reduction in thickness of the antenna device further including the transmitting and receiving circuit. Further, as compared to an arrangement in which the antenna element and the transmitting and receiving circuit are provided in different planes, it is possible to shorten a conduction route for connection between the antenna element and the transmitting and receiving circuit. This eliminates the need for consideration to impedance of a transmission route between the antenna element and the transmitting and receiving circuit.

The present invention is not limited to the descriptions of the respective embodiments, but may be altered within the scope of the claims. An embodiment derived from a proper combination of technical means disclosed in different embodiments is encompassed in the technical scope of the invention.

### INDUSTRIAL APPLICABILITY

The present invention is applicable to a broadcast wave reception-use antenna device which can be mounted on a movable body. Specifically, the present invention can be utilized in, for example, an antenna device for use in a movable body including a display-capable wireless device which can carry out transmission and reception in various frequency bands including a VHF broadcast band and a UHF terrestrial digital broadcast band.

### REFERENCE SIGNS LIST

1, 10, 20, 30 Antenna device
2 Body (outer shell)
3, 3a, 3b Antenna
4 Tuner section (transmitting and receiving circuit)
5 Base member (support)
6a, 6b, 6c Radome (support)
11 Spacer (support)
12 Base member (support)
201, 201a Antenna
211, 211a Wind section (first region)
213 First wider width part (wider width part)
214 Second wider width part (wider width part)
221, 221a Coaxial cable (feed line)
222, 222a Feed section
225, 225a First root section
226, 226a Second root section
225o2 First bending part (first tail end linear part)
226o2 Second bending part (second tail end linear part)
231, 231a, 231c, 231d, 232a Short-circuit member (short-circuit section)
401 Antenna device
402 Dielectric material layer (dielectric material)
501, 502, 503, 504 Antenna
601 Automobile (movable body)

1. An antenna device comprising:
a plate-like antenna element having an electrically conductive path arranged in a two-dimensional manner;
a feed line connected to the antenna element; and
a support, while causing the antenna element to be spaced away from an electrically conductive material layer of an outer shell of a movable body, holding the plate-like antenna element in such a manner as to conform to a front surface or a back surface of the outer shell,
the plate-like antenna element comprising: (i) a first root section being a part of the antenna element which part extends from one end part of the electrically conductive path by a predetermined length; (ii) a second root section being a part of the antenna element which part extends from the other end part of the electrically conductive path by a predetermined length; and (iii) an intermediate section which is a junction between the first root section and the second root section,
the first and second root sections having first and second feed sections respectively provided therein, the first and second feed sections being each connected to the feed line,
the intermediate section having the electrically conductive path provided therein, the electrically conductive path having a meander shape with a return pattern, and
the support being made from a dielectric material.

2. The antenna device according to claim 1, wherein
the plate-like antenna element is provided with a short-circuit section for short-circuiting the electrically conductive path having the meander shape.

3. The antenna device according to claim 1, wherein
the plate-like antenna element is configured such that:
the first and second root sections constitute a wind section surrounding the feed sections; and
at least one of the first and second root sections has a wider width part of the electrically conductive path, the wider width part being formed such that a portion that overlaps the feed line connected with the feed section is larger in width than other portions.

4. The antenna device according to claim 1, wherein
the plate-like antenna element is a single line continuing from its one end part to the other end part.

5. The antenna device according to claim 1, wherein
the antenna element is spaced at a distance of at least 2 mm away from the front surface or the back surface of the outer shell.

6. The antenna device according to claim 1, further comprising:
fixing means for fixing the support onto the outer shell, wherein
the support is a plate-like base member, and
the antenna element is fixed on a surface of the base member while conforming to the surface of the base member.

7. The antenna device according to claim 1, further comprising:
fixing means for fixing the support onto the outer shell, wherein
the support is a cover member which covers a part of the surface of the outer shell therewith,
the cover member forms a space between an inner wall thereof and the surface of the outer shell, and
the plate-like antenna element is fixed on a surface of the inner wall of the cover member while conforming to the surface of the inner wall of the cover member.

8. The antenna device according to claim 1, wherein
the plate-like antenna element is provided in such a manner so as to be bowed at a curvature radius of 5 mm or greater.

9. The antenna device according to claim 1, further comprising:
a transmitting and receiving circuit which is connected to the plate-like antenna element via the feed line, wherein
the plate-like antenna element and the transmitting and receiving circuit are provided in a single plane.

10. A movable body comprising:
an antenna device comprising:
a plate-like antenna element having an electrically conductive path arranged in a two-dimensional manner;
a feed line connected to the antenna element; and
a support, while causing the antenna element to be spaced away from an electrically conductive material layer of an outer shell of a movable body, holding the plate-like antenna element in such a manner as to conform to a front surface or a back surface of the outer shell,
the plate-like antenna element comprising: (i) a first root section being a part of the antenna element which part extends from one end part of the electrically conductive path by a predetermined length; (ii) a second root section being a part of the antenna element which part extends from the other end part of the electrically conductive path by a predetermined length; and (iii) an intermediate section which is a junction between the first root section and the second root section,
the first and second root sections having first and second feed sections respectively provided therein, the first and second feed sections being each connected to the feed line,
the intermediate section having the electrically conductive path provided therein, the electrically conductive path having a meander shape with a return pattern, and
the support being made from a dielectric material, wherein
the antenna device is mounted to a front surface or a back surface of an outer shell of the movable body.
